(19) United States
(12) Patent Application Publication
(10) Pub. No.: US 2023/0036244 A1
(43) Pub. Date: Feb. 2, 2023

(54) NON-FLAMMABLE POLYMERIC ELECTROLYTE WITH WIDE OPERATIONAL TEMPERATURE RANGE

(71) Applicant: The Board of Trustees of the Leland Stanford Junior University, Stanford, CA (US)

(72) Inventors: Zhuojun Huang, Stanford, CA (US); Jiancheng Lai, Mountain View, CA (US); Zhenan Bao, Stanford, CA (US); Yi Cui, Stanford, CA (US)

(73) Assignee: The Board of Trustees of the Leland Stanford Junior University, Stanford, CA (US)

(21) Appl. No.: 17/861,081

(22) Filed: Jul. 8, 2022

Related U.S. Application Data
(60) Provisional application No. 63/219,517, filed on Jul. 8, 2021.

(51) Int. Cl. H01M 10/0565

(52) U.S. Cl. CPC H01M 10/0565; H01M 10/0525

(57) ABSTRACT

The present embodiments relate to lithium-based batteries, and particularly to coordinated solvent molecules that can increase the ionic conductivity of the electrolyte without undermining its non-flammability. Some embodiments include a liquid-state polymer electrolyte composed of LiFSI salts, Dimethoxyethane (DME) solvents, and polysiloxane tethered with ion solvating moieties. DME coordinates with both the salt and the polymer, while together with the salt, they synergistically plasticize the polymer to increase the ionic conductivity. The resulting non-flammable polymer electrolyte has a room temperature ionic conductivity of 1.6 mS/cm and a wide operation window of 25-100° C. Benefiting from its liquid nature, the electrolyte can pair with commercially available electrodes without further cell engineering. Embodiments can extend the ionic conductivity range of polymer electrolytes and provide a new design pathway for next generation safe and manufacturable electrolytes.

### CROSS-REFERENCE TO RELATED APPLICATIONS

The present application claims priority to U.S. Provisional Patent Application No. 63/219,517, filed Jul. 8, 2021, the contents of which are incorporated herein by reference in their entirety.

### STATEMENT OF GOVERNMENT RIGHTS

This invention was made with Government support under contract DE-AC02-76SF00515 awarded by the Department of Energy. The Government has certain rights in the invention.

### TECHNICAL FIELD

The present embodiments relate generally to batteries, and more particularly to amphiphilic polymer backbone-sidechain design using Poly(dimethylsiloxane) (PDMS) backbone tethered with ionic liquid functioned chains.

### BACKGROUND

Lithium-ion batteries (LIBs) have applications ranging from grid level energy storage to portable consumer electronic devices. However, flammability of traditional electrolytes remains a critical safety issue. The electrolyte is usually comprised of flammable small organic molecules, such as ether and carbonate. Their volatility leads to unsafe battery operation at temperatures beyond 60° C. Specifically, these organic molecules undergo self-amplifying exothermic oxidation, which eventually lead to battery combustion. Ionic liquid-based electrolyte has been explored as a low vapor pressure safe electrolyte. However, these ionic liquids introduce a secondary mobile cation beyond Li⁺ into the solution matrix. Due to the salt solvating limitation of ionic liquid (molar Li salt:ionic liquid≤1:2), majority (≥67%) of the mobile cations in the electrolyte are organic cations, instead of Li⁺. This results in a low lithium transference number (<0.4) in these electrolytes.

It is against this technological backdrop that the present Applicant sought to obtain a technological solution to these and other problems rooted in this technology.

### SUMMARY

One or more embodiments relate to a siloxane-based polymer, using ionic-liquid based solvating unit as polymer side chains. The flexible low T_{g} (glass transition temperature) backbone promotes polymer chain motion and elevates baseline ionic conductivity. By moving the ion solvating units from the polymer backbone to the side chain, the present embodiments reduce their steric hindrance and enables higher salt solubility, which further increase the ionic conductivity and decrease the viscosity of this electrolyte. Solvent molecules can be incorporated into the electrolyte to maintain high ionic conductivity without impacting its non-flammability. These solvents exist in a highly coordinated environment with salts and polymers and does not undercut the safety feature of the electrolyte.

The resulting polymer electrolyte with high lithium salt content (salt:monomer=8:1), in presence of coordinated DME (Dimethoxyethane) molecules, is a liquid with ionic conductivity of 1.6 mS/cm at 25° C. Compared to solid state electrolyte (ceramic or polymer), this liquid electrolyte easily formed intimate contact with the electrodes and can be paired with commercially available nickel manganese cobalt oxide (NMC) cathodes without further cell engineering. By tethering the ionic liquid units to the polymer side chain, instead of using small molecule ionic liquid, limited was the movement of the non-Li cation in the system and achieved was high Li transference number (˜0.7). A stable cycling of this safe and non-flammable electrolyte can be obtained with NMC cathodes and graphite anode at 25° C. (C/10 and C/3) for over 400 cycles with negligible capacity fading. This electrolyte can operate at a wide temperature range with realistic current densities (25° C., 0.27 mA/cm², 100° C., 5.4 mA/cm²) and sets the conductivity and performance standards for polymer electrolytes.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIGS. 1A to 1G illustrate example aspects of a PPyMS-FSI polymeric electrolyte according to embodiments: FIG. 1A is a schematic of the chemical structure of an example electrolyte drawn with the molar ratio of LiFSI:PyFSI:DME=1:1:1; FIG. 1B illustrates the liquid-state polymeric electrolyte added to battery separator, and a zoom-in cartoon (drawn with the molar ratio of LiFSI:PyFSI:DME=2:1:1.5) structure of the complex; FIG. 1C is a graph that illustrates the DME amount in the electrolyte after 48 hrs of drying as the salt content increase; FIG. 1D is a graph that illustrates the ionic conductivity of the electrolyte with increased amount of salt concentration in the system measured at 25° C.; FIG. 1E is a graph that illustrates the steady-state viscosity of the electrolyte at different r values; FIG. 1F is a graph that illustrates the conductivity of the PPyMS-FSI r=8 electrolyte at different temperatures, and compared with other dry polymer-in-salt electrolyte; FIG. 1G is a schematic showcasing how this liquid-state polymeric electrolyte's unique advantage.

FIGS. 2A to 2E illustrate example aspects of the coordination environment of Li+, FSI− and DME according to embodiments: FIG. 2A is an example Raman spectroscopy of the polymer-salt complex focused on the vibration mode of the S-N-S bond on the FSI anion; FIG. 2B is a graph that illustrates the Fourier-transform infrared spectroscopy (FTIR) of the polymer-salt complex focused on the signal range of the vibration mode of the S-N-S bond on the FSI anion; FIG. 2C is a graph that illustrates Lithium nuclear magnetic resonance (NMR) signals of polymers with various salt content measured at 25° C.; FIG. 2D illustrates example Raman spectroscopy focused on DME vibration with Li—O breathing bond marked out; FIG. 2E illustrates example Raman spectroscopy focused S-N-S bond stretching compared with 4M and 8M LiFSI DME solution (feed composition).

FIGS. 3A to 3H illustrate example aspects of the stability and electrochemical characterization of the PPyMS-FSI r=8 electrolyte according to embodiments: FIG. 3A is a graph illustrating Linear sweep voltammetry (LSV) performed on the electrolyte in a Li|Al cell. The measured oxidative stability is compared with that of other common polymer/liquid electrolytes; FIG. 3B is a graph illustrating rate-dependent capacity of graphite|NMC cell. Long-term cycling of graphite|NMC cell is provided at (FIG. 3C) C/10 c-rate, and (FIG. 3D) C/3 c-rate; FIG. 3E illustrates SEM images of lithium deposition morphology (1 mAh/cm² capacity, 0.1 mA/cm² current density) on bare Cu foil; FIG. 3F is a Nyquist plot of the impedance measurements on Li|Li symmetric cell with PPyMS-FSI r=8 electrolyte after various resting time at room temperature. Long-term cycling of Li|Li cell is illustrated at FIG. 3G for 1 mA/cm² current density, 1 mAh capacity, and at FIG. 3H for 2 mA/cm² current density, 2 mAh capacity.

FIGS. 4A to 4D illustrate example aspects of Thermal stability of PPyMs-FSI r=8 electrolyte according to embodiments: FIG. 4A is a Snapshot of glass wool soaked with 1 ml of either PPyMS-FSI r=8 or EC/DEC 1M LiPF₆ 10% FEC electrolyte and a flame torch was placed in contact with the glass wool for 3 seconds before removed; FIG. 4B is a snapshot of pouch cell with either PPyMS-FSI r=8 or EC/DEC 1M LiPF₆ 10% FEC electrolyte operating an LED light while placed on a hotplate with the temperature of the hotplate indicated in the picture; FIG. 4C illustrates Lithium|NMC cells with 30 μL of PPyMS-FSI r=8 electrolyte, 300 μm lithium anodes and 2.7 mAh NMC 532 lithium cathodes was cycled in different C-rate at 25° C.; FIG. 4D is a graph comparing the current density of the PPyMS-FSI r=8 electrolyte with other dry polymeric electrolytes in the literature.

FIG. 5 illustrates an example 1H NMR spectrum of the as-prepared polymer electrolyte PPyMS-FSI-r=8 dried in a vacuum oven for 48 hrs at 70° C. The peaks j and k belong to the residual DME. The integration of peak h (2.0-2.2 ppm) is equal to the stoichiometric ratio of peak e, indicating there is no residual ACN (2.06 ppm) in the prepared polymer electrolyte. The integration of g and f are hidden by peak j and k, so they are integrated together and minus the integration of g and f according to the stoichiometric ratio when calculating the molar ratio of residual DME.

FIGS. 6A to 6H illustrate example 1H NMR spectra of the polymer electrolyte prepared by mixing polymer solution in ACN and LiFSI solution in DME, then rotory-apped and dried in vac oven (70 Torr, 70° C., 48 hrs). Detailed peak assignment were shown in FIG. 5. The polymer electrolyte with different content of LiFSI are listed: FIG. 6A R=0, FIG. 6B R=0.01, FIG. 6C R=0.1, FIG. 6D R=0.2, FIG. 6E R=0.5, FIG. 6F R=1, FIG. 6G R=2, and FIG. 6H R=5. The ratio of integration of peaks at 2.0-2.2 ppm (peak h, supplementary FIG. 1) are all almost equal to 4, which means there is no residual ACN in the as-prepared polymer electrolytes. The ratio of integration of peak at 3.2-3.6 ppm was assigned to hydrogens on DME (shaded green, peak k, j, FIG. 5) gradually increases when increasing the ratio of LiFSI, which means that the ratio of residual DME also gradually increases. One can calculate the molar ratio of the DME to the monomer, in reference to the hydrogens on the side chain (shaded red, peak e, FIG. 5), and the results were shown in FIG. 1C.

FIG. 7 illustrates example steady state viscosity measurement of PPyMS-FSI r=8 electrolyte at different drying time. The experiment was conducted in a parallel plate rheometer in an ambient environment.

FIG. 8 illustrates example viscosity of the polymer-salt complex at different r values measured at ambient conduction (air, 25° C.).

FIG. 9 illustrates example rheological characterization of the polymer's mechanical properties: the loss and storage moduli of polymers with different salt content (different r) measured at the frequency range of 1-100 rad/s at 25° C., 10° C. and 45° C. and then superimposed to 25° C. using the temperature shift parameter aT.

FIG. 10 illustrates example differential scanning calorimetry (DSC) measurements of the polymers with different r values and the glass transition temperatures (Tg) marked out in the graphs.

FIGS. 11A and 11B illustrate example impedance Spectroscopy of PPyMS-FSI r=8 polymeric electrolytes at different temperature (25° C., 40° C., 55° C., 70° C., 85° C., 100° C., marked with different colors), with the right and left side images showcasing the zoom out and in impedance spectroscopy.

FIG. 12 illustrates example Arrhenius fitting of PPyMS-FSI r=8 polymers the fitting parameters listed.

FIG. 13 illustrates example Raman spectrum of either the polymers or the salt measured with a 532 nm laser. The name of the sample is labelled as the legend. As the salt content increases, the polymer becomes more and more liquid like, and the Raman signals of the glass slide encasing (˜520 cm-1, ˜790 cm-1) are becoming more and more obvious.

FIG. 14 illustrates an example full spectrum of the FTIR measurements with different salt content outlined by different salt concentration, and the grey areas is the zoomed in section in the main figure. The arrow indicates the direction shift of the peak position as the salt concentration increases.

FIG. 15 illustrates an example 7Li NMR of the lithium nuclei as the salt concentration of the salt/polymer increases. The grey out areas are the two NMR measurements of 1M LiCl salt dissolved in D20 before and after the series of experiments was conducted, and we observed that the shift in the lithium signal is significantly large compared to the shift of the reference before and after the experiments.

FIGS. 16A to 16C illustrate example radial distribution functions (RDFs) in the r=1 electrolyte: FIG. 16A, RDF analyzing the interactions between the Li cation (the reference atom) and the oxygen atoms in DME and in FSI anions (closeup of short-ranged region inset);

FIG. 16B, RDF analyzing the interactions between the oxygen in the FSI anion (the reference atoms) and the oxygen in DME and Li cations (closeup of short-ranged region inset); FIG. 16C, RDF analyzing the interactions between the oxygen in DME (the reference atom) and the nitrogen in Py+ on the polymer side chain.

FIGS. 17A and 17B illustrate an example fitting of the Diffusion Ordered SpectroscopY (DOSY) NMR of the 7Li and 19F nuclei at 80° C. is shown, and the slope of the linear fit is the diffusion constant of the 19Li (I: NMR intensity as a function of gradient strength (g), Io: initial intensity (507), γ: gyromagnetic ratio (25162.3), g: gradient strength, δ: pulse duration (0.005), Δ: gradient pulse interval (0.7), τ1 (0.00022) and τ2 (0.002): time scale correction, C: fitting constant (3.88×10⁻²)). The transference number of the PPyMS-FSI r=8 electrolyte was calculated from the fitted diffusion constant of the two nuclei.

FIG. 18 illustrates an example Transference number measurement of the PPyMS-FSI r=8 electrolyte with Li|Li symmetric cell at room temperature.

FIGS. 19A and 19B illustrates example long-term cycling of graphite anodes and NMC cathodes using PPyMS-FSI r=8 electrolytes with two repetitions FIG. 19A and FIG. 19B.

FIG. 20 is example SEM images of 1 mAh cm-1 of Li deposited on a Cu foil at the current density of 0.1 mA cm⁻¹.

FIG. 21 is an example XPS of Graphite Anode surface after 10 cycles at different C-rate with PPyMS-FSI r=8 electrolyte.

FIG. 22 is an example XPS of Li metal anode surface after 10 cycles at different C-rate with PPyMS-FSI r=8 electrolyte.

FIG. 23A is an example SEM cross section of the graphite|NMC before cycling, with each component of the cell marked out; FIG. 23B illustrates the EDS mapping of Si K edge; FIG. 23C illustrates the EDS mapping of Mn K edge indicating cathode layer in the bottom.

FIG. 24A is an example SEM cross section of the graphite|NMC after 50 cycles, with each component of the cell marked out; FIG. 24B illustrates the EDS mapping of Si K edge; FIG. 24C illustrates the EDS mapping of Mn K edge indicating cathode layer in the bottom.

FIG. 25 illustrates an example EIS curve of polymer electrolyte measured at room temperature.

FIGS. 26A and 26B illustrate aspects of an example composition of SM electrolyte: FIG. 26A illustrates chemical structure of Py12FSI; FIG. 26B illustrates molar composition of SM electrolyte.

FIG. 27 illustrates example ionic conductivity of the electrolytes referenced to the conductivity measured at day 1 (100%). The electrolyte samples were rested at 70° C., and the conductivity was measured at room temperature.

FIGS. 28A and 28B are snapshots of a flammability test for SM electrolyte.

FIGS. 29A and 29B illustrate an example experimental set up to characterize the polymer-based electrolyte on lighting LED on top of hot plate.

FIGS. 30A and 30B are digital images of placing the pouch cell with different electrolyte on the hot plate: FIG. 30A, PPyMS-FSI r=8; FIG. 30B, EC/DEC LiPF6 10% FEC. The thermocouple feedback to the hotplate was placed on top of the pouch cell to ensure homogenous heating of the pouch cell. The pouch cell was tapped onto the hot plate with Kapton tapes. The highlighting red box denotes the edges of the pouch cell rising due to outgassing in the pouch. The pouch cell was charged to 4 V prior to the demonstration.

FIGS. 31A and 31B illustrate experimental detail on measuring the relative saturation of the liquid electrolyte. FIG. 31A is a digital image of the oil bath heating set-up; FIG. 31B illustrates the gas chromatography curve (GC) of PPyMS-FSI r=8 (48 hrs) electrolyte and the DME standard.

FIG. 32 illustrates synthesis of PPyMS-FSI: (i) Karstedt catalysis, toluene, 85° C., 12 h; (ii) (1) Toluene, 85° C., 12 h, (2) Methanol, 70° C., 12 h; (iii) Methanol, 25° C., 1 h. (iv) Methanol, 25° C., 1 h.

FIG. 33 illustrates example 1H NMR spectrum of PDMS-Br.

FIG. 34 illustrates example 1H NMR spectrum of PPyMS-Br.

FIG. 35 illustrates example Mixing and drying steps for the PPyMS-FSI electrolyte according to embodiments.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

### INTRODUCTION

As set forth above, lithium-ion batteries (LIBs) have applications ranging from grid level energy storage to portable consumer electronic devices. However, flammability of traditional electrolytes remains a critical safety issue. The present Applicant recognizes that solid-state electrolytes, such as ceramic-based and polymer-based electrolytes were developed as an alternative safe electrolyte. For ceramic-based electrolytes, high lithium-ion conductivities (1-10 mS/cm) have been revealed at room temperature. However, their reliance on advanced manufacturing methods, e.g. atomic-layer-deposition, for forming low-impedance interfaces with the electrodes, has hindered their further development. For solid-state polymeric electrolytes, low bulk ionic conductivities (<0.1 mS/cm) at room temperature have limited their operation to only elevated temperatures (60-80° C.). In full cell cycling, these electrolytes were also incorporated into the cathode binders to improve the ionic transport across the electrolyte-electrode interface.

The present Applicant further recognizes that the limiting bulk and interfacial ionic conductivity of polymeric electrolyte is due to the coupled relationship between ionic conduction and polymer chain motion. In polymers such as poly(vinylidene fluoride)-co-hexafluoropropylene (PVDF-HFP), poly(methyl methacrylate) (PMMA), and poly(butyl acrylate) (PBuA), poly(diallyldimethylammonium) bis(fluorosulfonyl)imide (PDADFSI) increasing the salt contents shields secondary interactions between polymer chains, and resulted in reduced glass transition temperatures (Tg) and elevated ionic conductivities. However, previously used polymers, primarily based on readily commercial polymers, have rigid backbone and have limited salt solubility (max molar ratio salt:monomer typically <2:1). The rigid backbone restricts the polymer chain motion and thus the ionic conductivity. Although salt addition can increase the ionic conductivity, this is limited by their deficient salt solubility. In these polymer-in-salt systems, the ionic conductivity usually plateaued ˜0.1 mS/cm (25° C.). Another way to increase the polymer chain motion is adding organic liquids or oligomers (e.g. Gel electrolyte). However, these liquid additives can undermine the thermal stability and non-flammability of polymer electrolyte if their solvation environment and volatility were not carefully examined.

According to certain aspects, the present embodiments relate to a siloxane-based polymer, using ionic-liquid based solvating unit as polymer side chains. The flexible low T_{g} (glass transition temperature) backbone promotes polymer chain motion and elevates baseline ionic conductivity. By moving the ion solvating units from the polymer backbone to the side chain, the present embodiments reduce their steric hindrance and enables higher salt solubility, which further increase the ionic conductivity and decrease the viscosity of this electrolyte. Solvent molecules can be incorporated into the electrolyte to maintain high ionic conductivity without impacting its non-flammability. These solvents exist in a highly coordinated environment with salts and polymers and does not undercut the safety feature of the electrolyte. To quantify and compare the solvent volatility of this and other electrolytes, developed was a GC (Gas Chromatography) based measurement and found the partial vapor pressure of organic solvents in this electrolyte remains low (˜2%) in high temperature (100° C.) condition.

The resulting polymer electrolyte with high lithium salt content (salt:monomer=8:1), in presence of coordinated DME (Dimethoxyethane) molecules, is a liquid with ionic conductivity of 1.6 mS/cm at 25° C. Compared to solid state electrolyte (ceramic or polymer), this liquid electrolyte easily formed intimate contact with the electrodes and can be paired with commercially available nickel manganese cobalt oxide (NMC) cathodes without further cell engineering. By tethering the ionic liquid units to the polymer side chain, instead of using small molecule ionic liquid, we limited the movement of the non-Li cation in the system and achieved high Li transference number (˜0.7). A stable cycling of this safe and non-flammable electrolyte can be obtained with NMC cathodes and graphite anode at 25° C. (C/10 and C/3) for over 400 cycles with negligible capacity fading. This electrolyte can operate at a wide temperature range with realistic current densities (25° C., 0.27 mA/cm², 100° C., 5.4 mA/cm²) and sets the conductivity and performance standards for polymer electrolytes.

Materials Design

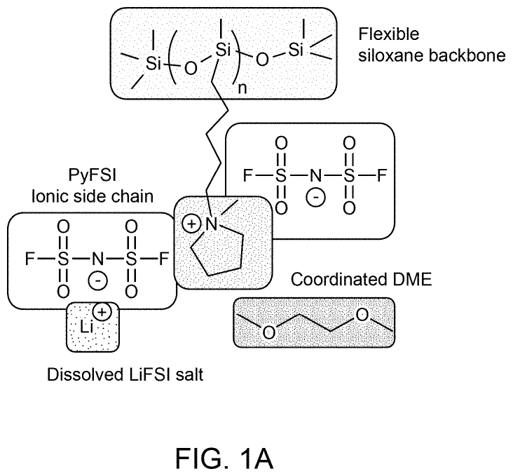

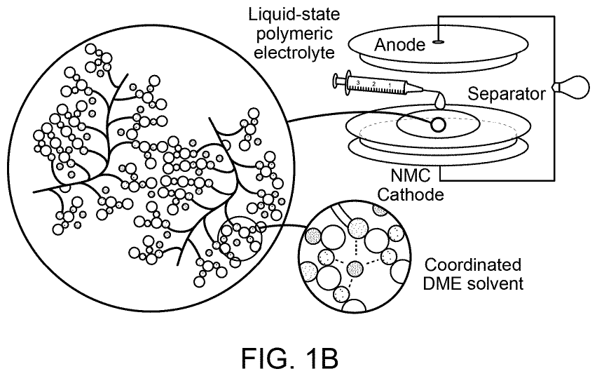

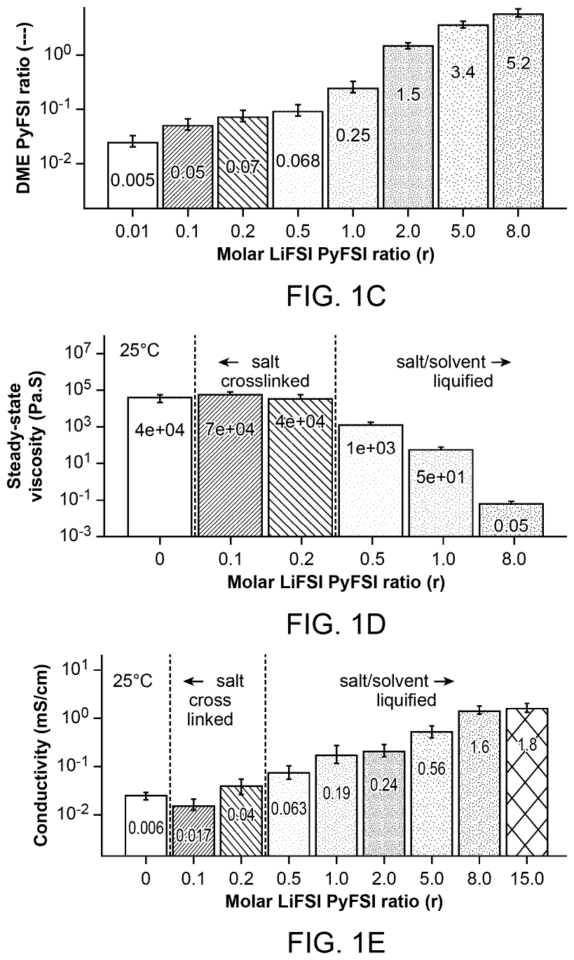

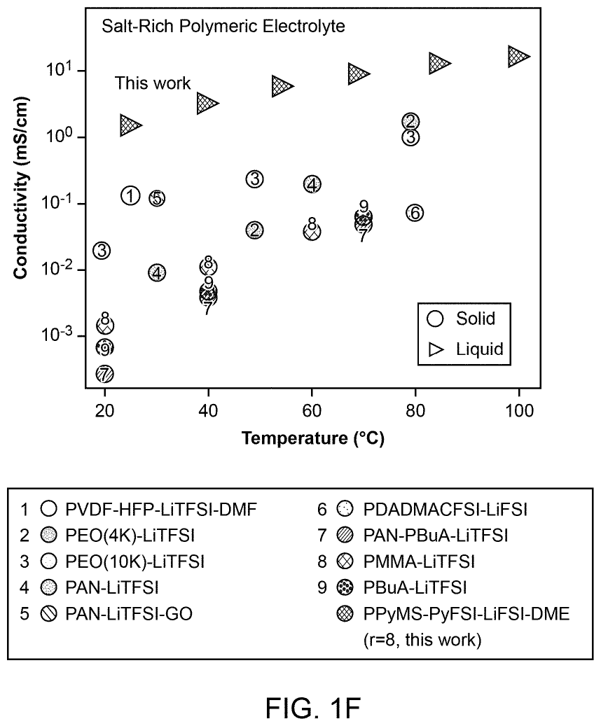

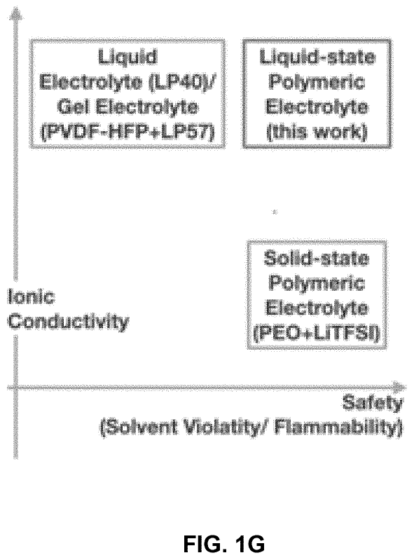

An amphiphilic polymeric electrolyte according to embodiments is comprised of non-polar siloxane backbone and pyrrolidinium (Py) bis(fluorosulfonyl)imide (FSI) polar ionic side chains, as shown in FIG. 1A, and the polymer is referred to herein as PPyMS-FSI. The siloxane backbone was chosen for its chemical stability and chain flexibility. The PyFSI ionic group was selected for its oxidative stability and ability to solvate salt. Other ionic liquid based polymer electrolyte has been studied, especially, a polymeric PyFSI ionic liquid as the polymer backbone and LiFSI (PDADFSI-LiFSI) as the salt was studied. At the salt: monomer ratio of 0.5 with minimal solvent presents, PDADFSI-LiFSI has ionic conductivity of 10⁻⁶ mS/cm at 30° C., while our polymer electrolyte PPyMSMS-LiFSI has ionic conductivity of 8.3*10⁻² mS/cm at 25° C., and the higher conductivity derived from the low rigidity of the siloxane polymer backbone. In this study, by moving the ionic solvation groups to polymer side chains, reduced was the steric hindrance of the ionic liquid and increased the freedom of the PyFSI unit to coordinate with salt and solvents as shown in FIG. 1B. Previous work also reported a polymer electrolyte with siloxane backbone tethered with imidazolium-based side chain with ˜10⁻³ mS/cm ionic conductivity at 25° C. with LiTFSI: side chain=0.03. Siloxane functioned ethers were also reported as a suitable electrolyte for lithium-ion batteries, and they can pair with high voltage cathodes when LiBOB (Lithium bis(oxalato)borate) salt was used.

Optimization of Electrolyte Composition

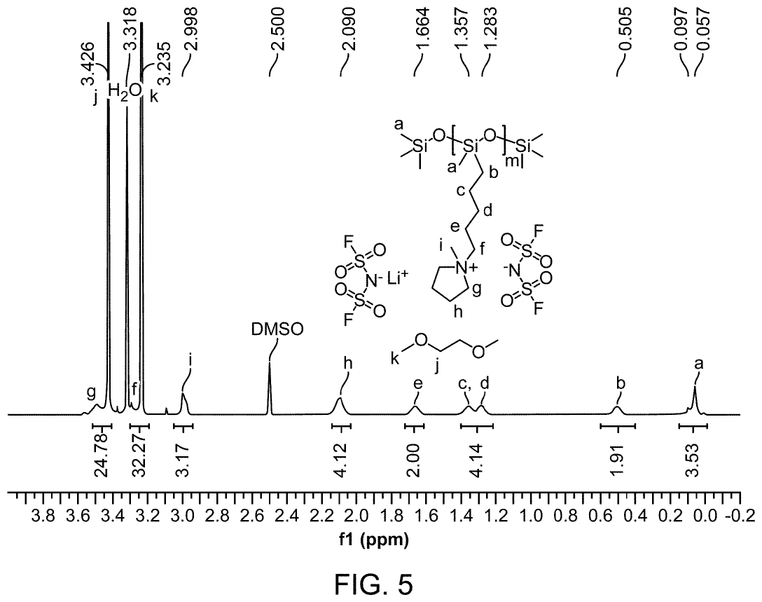

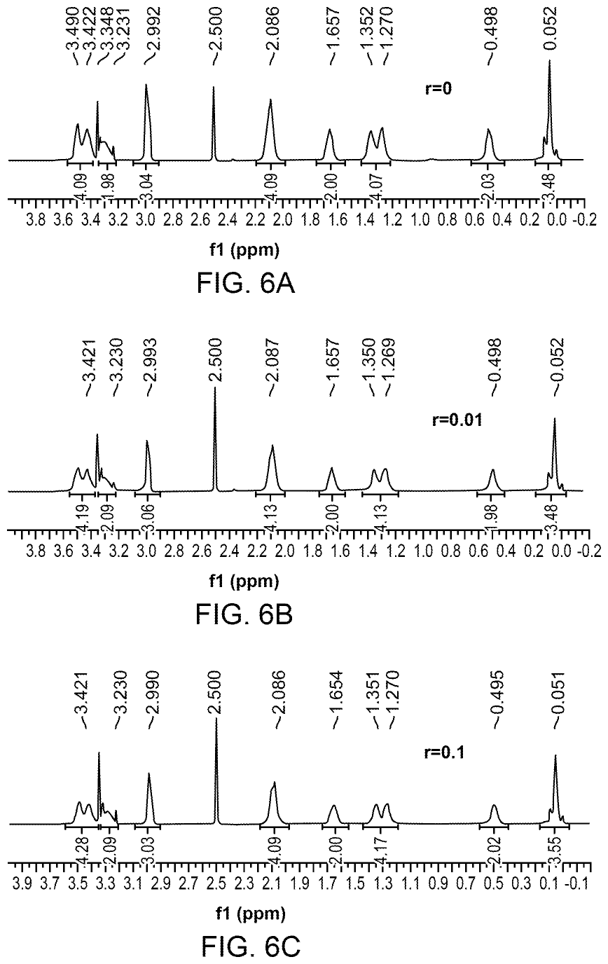

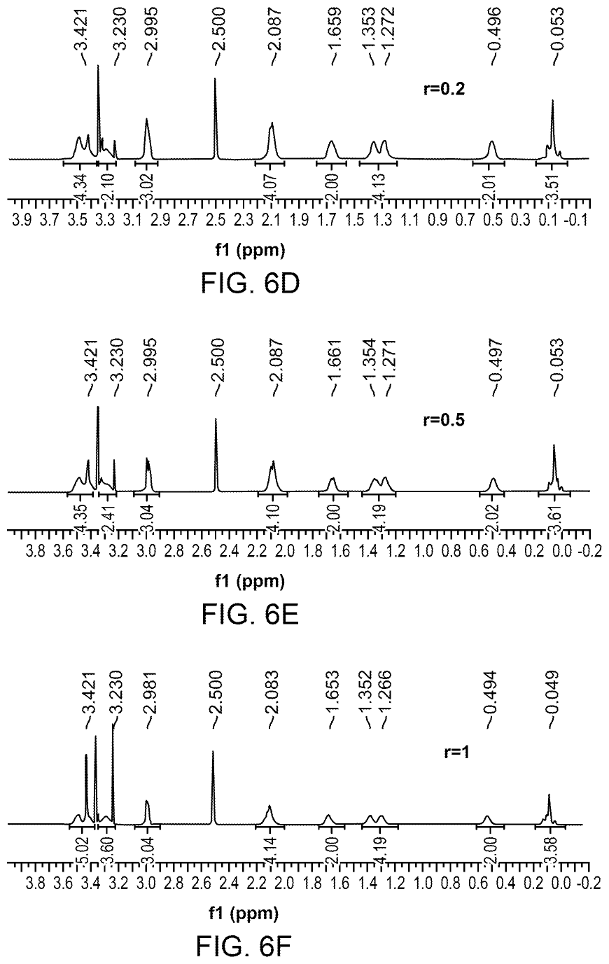

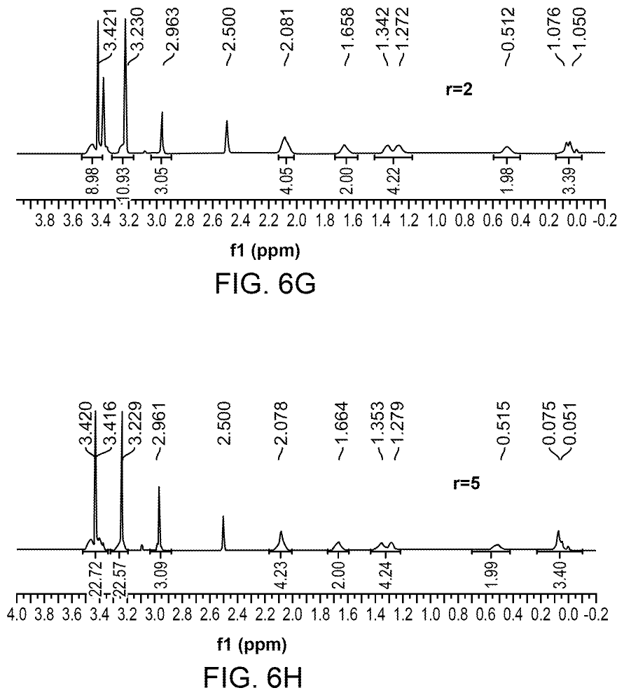

This electrolyte was prepared by dissolving the LiFSI salt in DME (dimethoxyethane) and PPyMS-FSI polymer in ACN (acetonitrile). After drying in a vacuum oven for 48 hrs, the ACN can be fully removed and the DME forms coordinated structures with polymers and salts. The residual amount was quantified with H-NMR for electrolytes at different salt concentrations (see FIGS. 5 and 6) and labelled as r_{DME} (molar ratio between DME and side chain) in FIG. 1C. Here is noted the salt content r, which is defined as the molar ratio between the added LiFSI salt and the PyFSI polymer side chain.

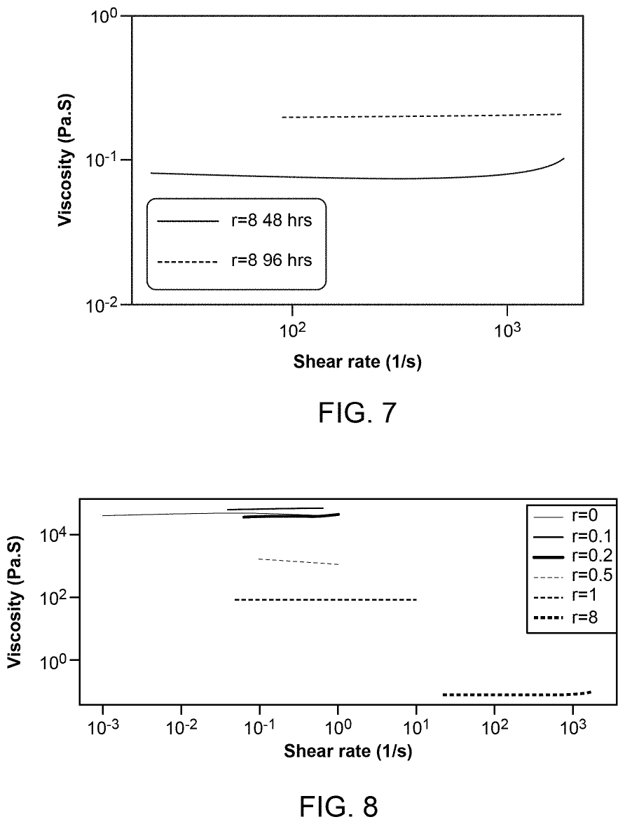

For the PPyMS-FSI r=8 electrolyte, optimized was the DME amount in the system by increasing the drying time from 48 to 96 and 144 hrs. From 48 to 96 hrs, the DME amount (r_{DME}) decreased from 5.25 to 2.53 (see Table 1 below), but the viscosity increased from 0.08 Pa·S to 0.2 Pa·S (see FIG. 7), and the conductivity decreased from 1.6 mS/cm to 0.54 mS/cm. Further extending the drying time (144 hrs) resulted in salt precipitation without fully removing the DME. At 48 hrs of drying time, the DME in the system is optimal for reducing the viscosity and promoting the ionic conduction. The following sections will showcase that the DME exist in a highly coordinated environment with low volatility, and the electrolyte is not flammable.

TABLE 1

| | Residual DME: | | Steady State |
|---|---|---|---|
| Drying time | PyFSI ratio | Conductivity | Viscosity |
| (hrs) | (r [symbol] ) | (mS/cm) | (Pa · S) |
| 48 | 5.25 ± 0.47 | 1.59 ± 0.35 | 0.08 ± 0.003 |
| 96 | 2.53 ± 0.26 | 0.54 ± 0.20 | 0.20 ± 0.004 |
| 144 | 1.3 ± 0.14 | 0.11 ± 0.02 | salt precipitation |

[symbol]

indicates data missing or illegible when filed

Liquid-State Polymeric Electrolyte

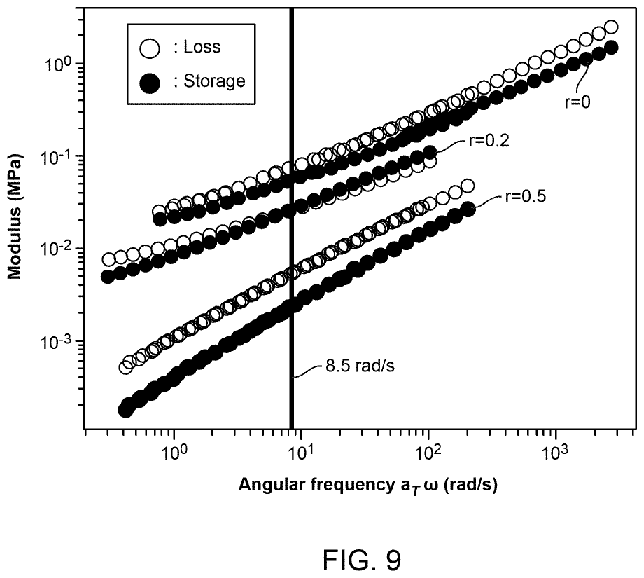

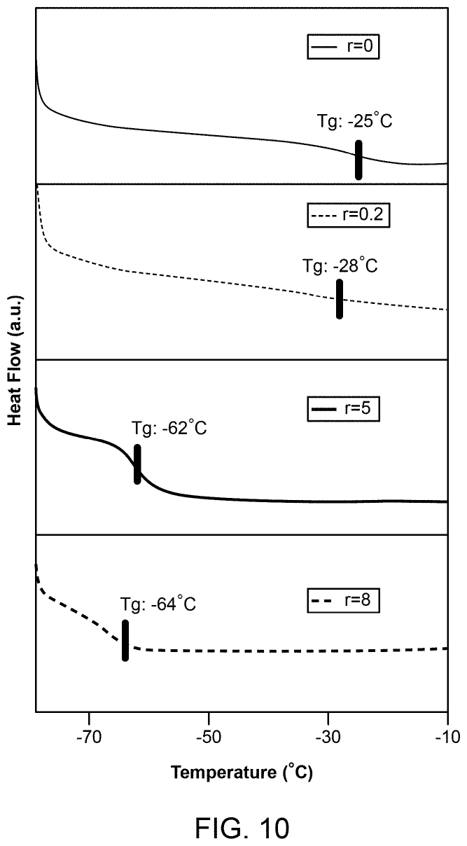

The mechanical properties and ionic conductivities of the salt-liquified polymer electrolyte are affected not only by the solvent, but also by the salt content. The steady-state viscosities (FIG. 1D, FIG. 8) and the ionic conductivities (FIG. 1E) of the polymeric complex at different r values were measured at 25° C. Due to the ionic nature of the PyFSI side chains, EIS (electrochemical impedance spectroscopy) measurement of the neat PPyMS-FSI (r=0), a viscous liquid, showed a 2.6×10⁻² mS/cm ionic conductivity at 25° C. When a small amount of LiFSI salt was added to the polymer matrix (i.e. r=0.1-0.2), Li⁺ established multi-coordination structures with the ionic side groups on the polymers, thereby electrostatically crosslinking the polymer chains and limiting the polymer chain motion. This salt-crosslinking behavior was characterized with frequency-dependent rheology on the r=0, r=0.2 and r=0.5 complex (FIG. 9). Polymer with no salt (r=0) showed liquid-like rheological property with the loss modulus (G″, liquid characteristic) lower than the storage modulus (G′, solid characteristic) across the frequency range, while r=0.2 had a crossover between G′ and G″ at 8.5 rad/s, demonstrating viscoelastic solid-like behavior. Further increase in salt and solvent content (r≥0.5) resulted in the electrolyte becoming liquid again with G″ higher than G′ over the frequency range. The solid/liquid transition was also reflected in viscosity and ionic conductivity changes: the steady-state viscosity of the polymer/salt mixture increased from 4×10⁴ Pa·S (r=0) to 7×10⁴ Pa·S (r=0.1) and then decreased to 8×10⁻² Pa·S (r=8); the conductivity decreased from 2.6×10⁻² mS/cm (r=0) to 1.7×10⁻² mS/cm (r=0.1) and then increased to 1.6 mS/cm (r=8). In obtained DSC curves (FIG. 10), the Tg of PPyMS-FSI r=0 was observed at −25° C., and the liquified PPyMS-FSI r=8 samples have Tg at −64° C., approaching the Tg of PDMS polymer without ionic interactions. These results suggested that the added LiFSI salt and DME can facilitate polymer chain motion and limit the ionic interaction between polymer side chains.

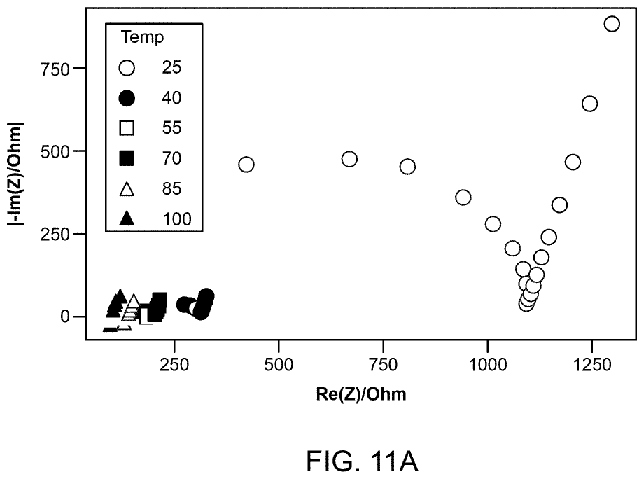

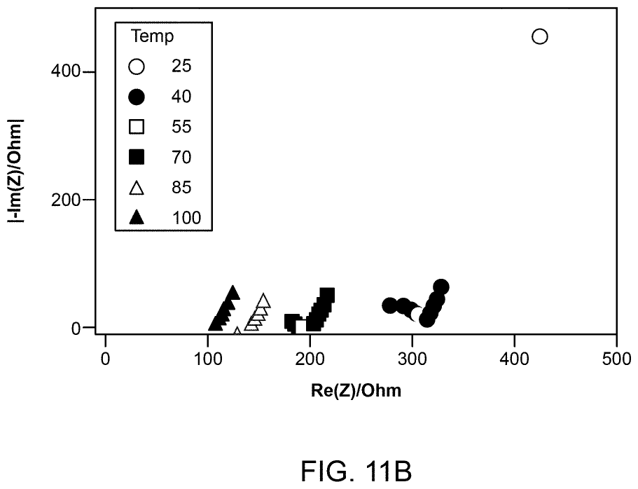

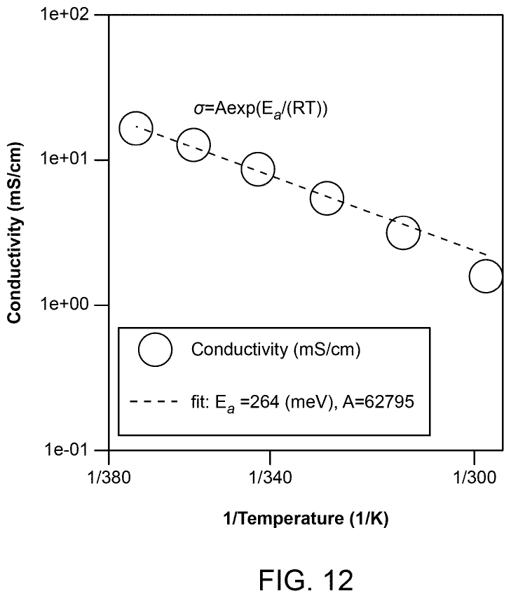

The ionic conductivity was next characterized over a wide temperature window from 25° C. to 100° C. (FIG. 1F) and obtained Nyquist plots are shown in FIGS. 11A and 11B. Through fitting the conductivity and temperature information using the Arrhenius equation (FIG. 12) for r=8, the activation energy required for ion transport was calculated as 264 meV. When comparing the conductivities of the PPyMS-FSI r=8 electrolyte with other polymer-in-salt electrolytes, this electrolyte showed the highest ionic conductivities across the entire temperature range of 25° C. to 100° C. Specifically, recent work on PVDF-HFP LiTFSI based polymer-in-salt electrolyte also reported 13 wt % of residual DMF. The electrolyte remained solid and demonstrated a room temperature ionic conductivity of 0.124 ms/cm. For short chain poly(ethylene glycol) (PEO, molecular weight 10 K), it can also be liquified by adding LiTFSI salt (Li: monomer=0.125), and has a viscosity of 55 Pa·S at 20° C. However, due to its limited ionic solvating ability, the liquefied PEO electrolyte only achieved an ionic conductivity of 0.06 mS/cm at 30° C.²⁷

By tuning the LiFSI and DME amount, preserved was the ionic conductivity without compromising the safety feature of polymeric electrolyte. This liquid-state polymeric electrolyte simultaneously addressed the solvent flammability issue of conventional liquid/gel electrolyte and the ionic conductivity limitation of solid-state polymeric electrolyte (FIG. 1G).

Chemical Environment of FSI, Li and DME

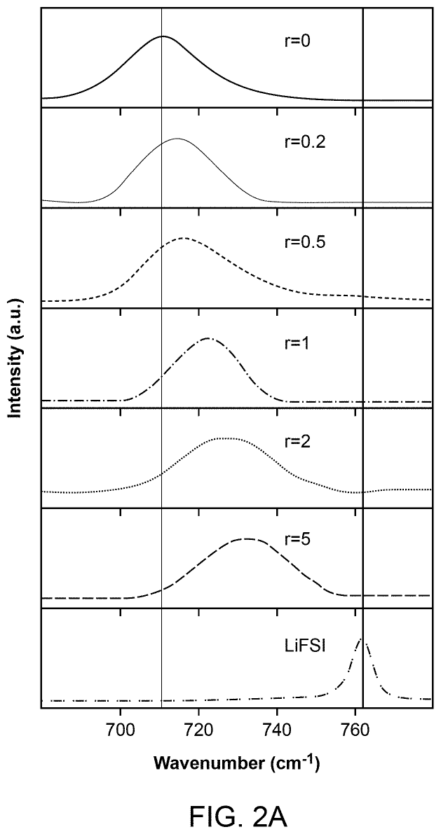

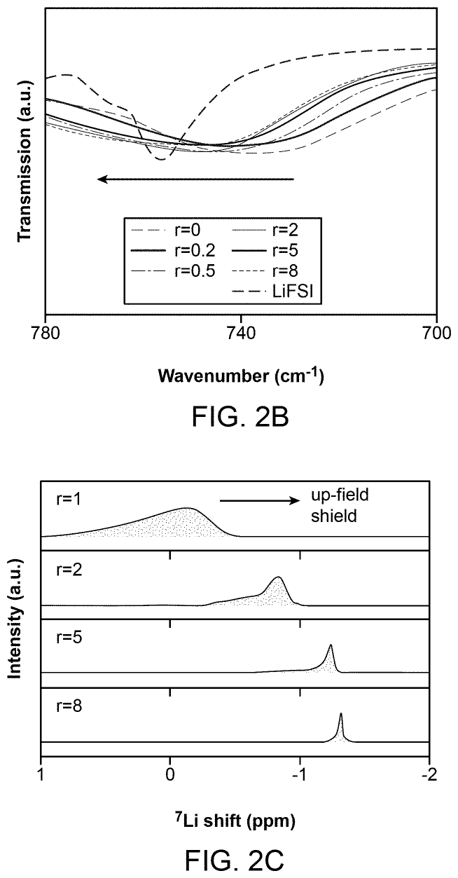

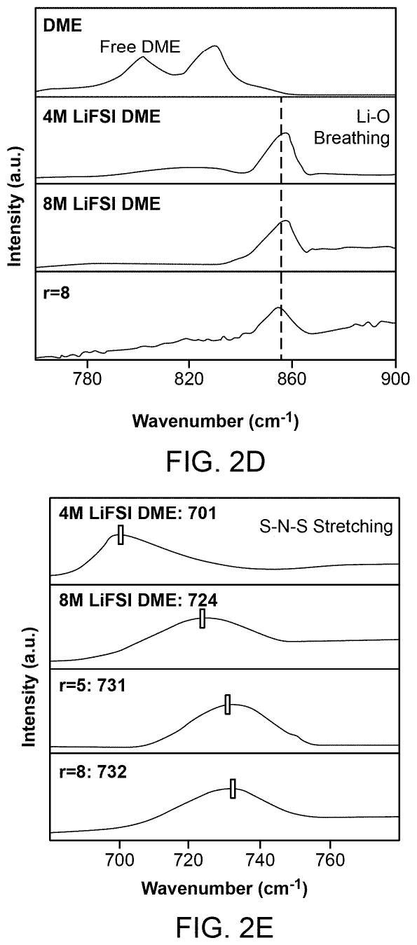

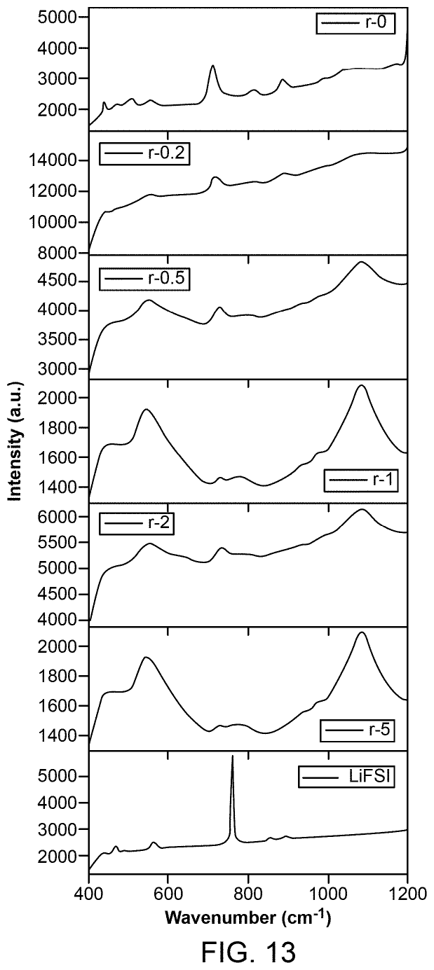

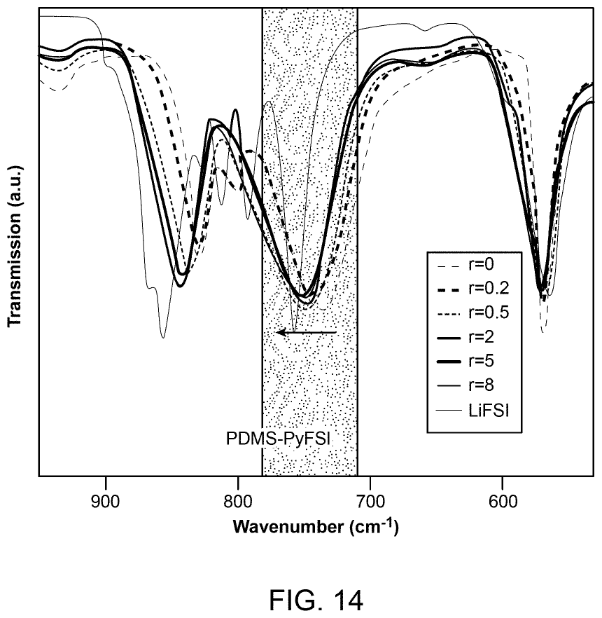

The chemical coordination environment of the Li cation and the FSI anion evolved with the electrolyte's composition. Raman spectroscopy can measure the shifts in energy level of specific vibration modes of bonds, and we can then infer the changes in the chemical environment of that bond. In this system, both the ionic side chain of the polymer and the added lithium salt contained the same FSI anion. As shown in FIG. 2A, the vibration energy of S-N-S bond measured for the PDMS-PyFSI system with no salt (r=0) was ˜711 cm⁻¹; for crystalline LiFSI salt samples it was ˜762 cm⁻¹. These results were similar to literature values of the S-N-S bond Raman signals on LiFSI salt and Pyrrolidinium FSI ionic liquids. All obtained Raman spectra are shown in FIG. 13. As the salt and solvent content increases, the S-N-S bond signal shifted to higher wavenumbers, indicating a more coordinated environment for the FSI anion. These Raman spectroscopy findings are further corroborated with Fourier-transform infrared spectroscopy (FTIR), where observed were regions containing the S-N-S bond stretching vibration (FIG. 2B and FIG. 14). As the salt content increased, the bond wavenumber in FTIR increased in the direction of Li binding with FSI, but no peak was observed at the energy of crystalline LiFSI.

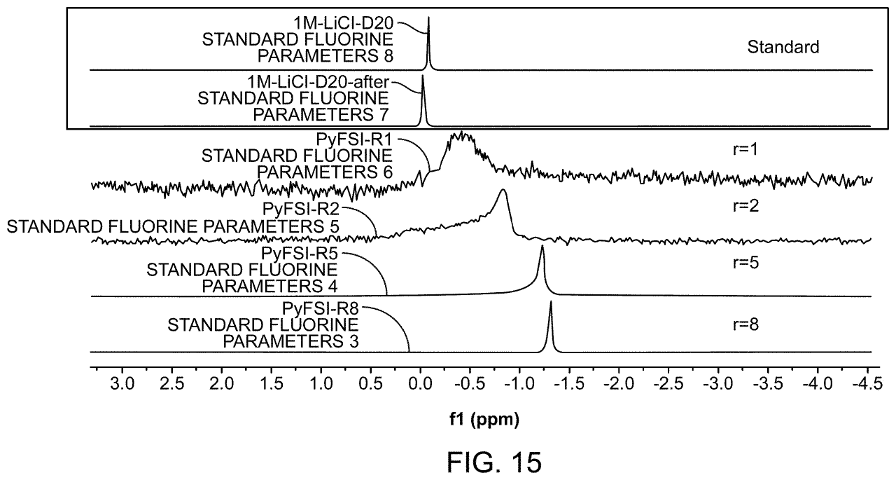

Besides characterizing the FSI anions, the chemical environment of lithium cations was investigated with NMR (Nuclear Magnetic Resonance). In FIG. 2C, the lithium peak showed an up-field shift as the salt content in the polymer increased. The full ⁷Li NMR spectrums are shown in FIG. 15. The up-field shift indicates a more shielded lithium nucleus due to a higher surrounding electron cloud density. Consistent with previous observations via Raman and FTIR, the increased salt content in the system resulted in a more coordinated solvation environment. The broadness of the NMR peak declined as the salt content increased, resulted from the lowered viscosity of the electrolyte. Furthermore, the distinct peak of lithium nuclei at high salt concentration (r=8) also indicated that the added lithium salts were fully dissolved in the matrix and existed in a uniform chemical environment.

The solvation environment of the DME in this polymer electrolyte system was characterized with Raman spectroscopy and compared it with high concentration LiFSI DME electrolyte. FIG. 2D shows the DME vibration signals. When there is no LiFSI in DME, pure DME exists in several confirmations, resulting in two distinct Raman peaks at wavenumber lower than 850 cm⁻¹. In the 4M and 8M LiFSI DME (feed composition) electrolytes, the Li—O breathing peak appeared at 856 cm⁻¹, indicating lithium cation is coordinating with the oxygen on DME. The coordination environments of the anion of the FSI anion in r=5 and r=8 electrolytes were also compared with 4M and 8M LiFSI DME electrolyte (FIG. 2E). When the salt concentration increased from 4M to 8M, the peak location shifted from 701 to 724 cm⁻¹. Compared to DME electrolyte with no polymer, the S-N-S stretching in the polymer electrolyte was further blue-shifted to >730 cm′, indicating that the PPyMS-FSI polymer also contributed to the highly coordinated environment.

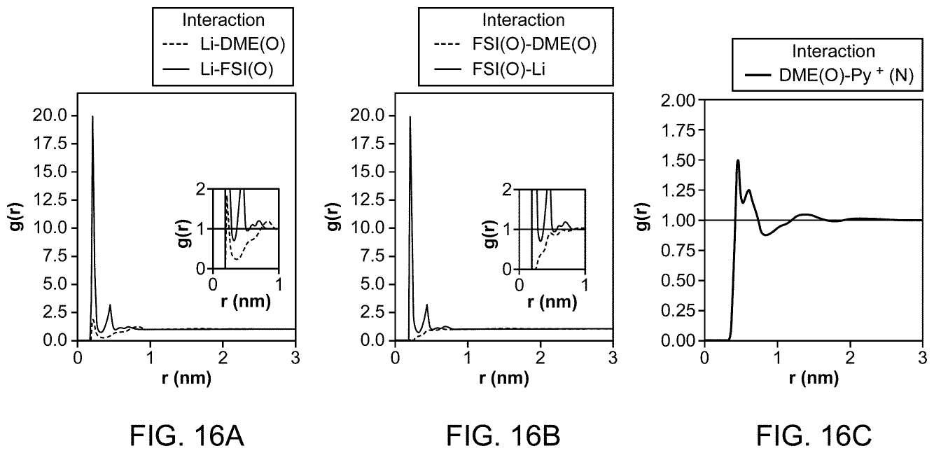

To complement experimental evidence, molecular dynamics (MD) simulations can also elucidate specific interactions in the system. Conducted were MD simulations for the r=1 electrolyte with the DME concentration shown in FIG. 1C and analyzed were the radial distribution functions (RDFs) to study the interactions between the electrolyte species (FIGS. 16A-C). At short range (<1 nm), a g(r) peak with a value larger than 1 indicates interaction between the two species of interest, as the local density of the selected species near the reference species is greater than its concentration in the bulk electrolyte. Li⁺ shows strong interaction with both the oxygen atoms in the FR⁻ and the oxygen atoms in DME, with clear peaks in the RDF. FSI⁻ interacts strongly with Li⁺, but has no distinguishable interaction with the DME. Besides interacting with Li⁺, it is also found that DME interacts with the Py⁺ group on the polymer side chain. Overall, these MD simulation results agree with the experimental finding that DME exists in a highly coordinated salt-rich environment, and DME interacts with both the Li⁺ and the polymer. In the following section, the volatility of the solvent molecule of this electrolyte is measured and compared with other gel and high salt concentration electrolytes. It is showed that the synergetic between the salt and the polymer coordination with the solvent molecule contributes to its low volatility and the overall non-flammable nature of this electrolyte.

Stability, Reactivity, and Electrochemical Characterizations

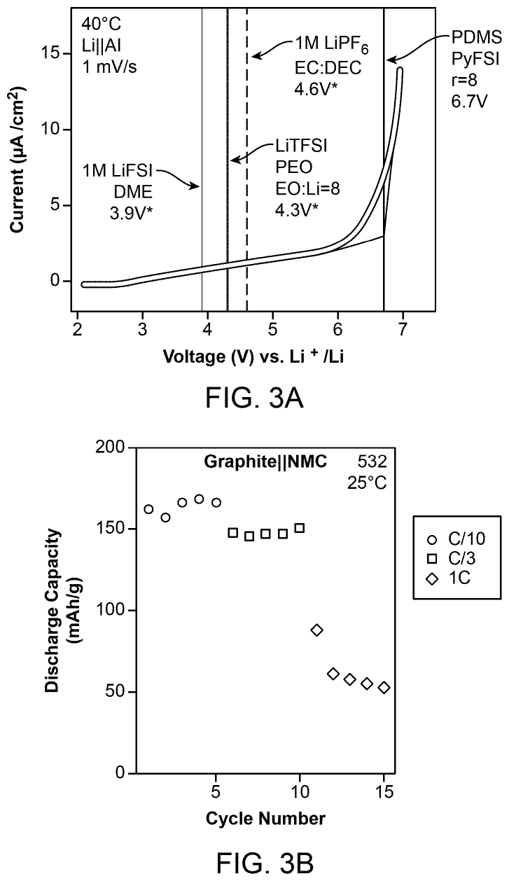

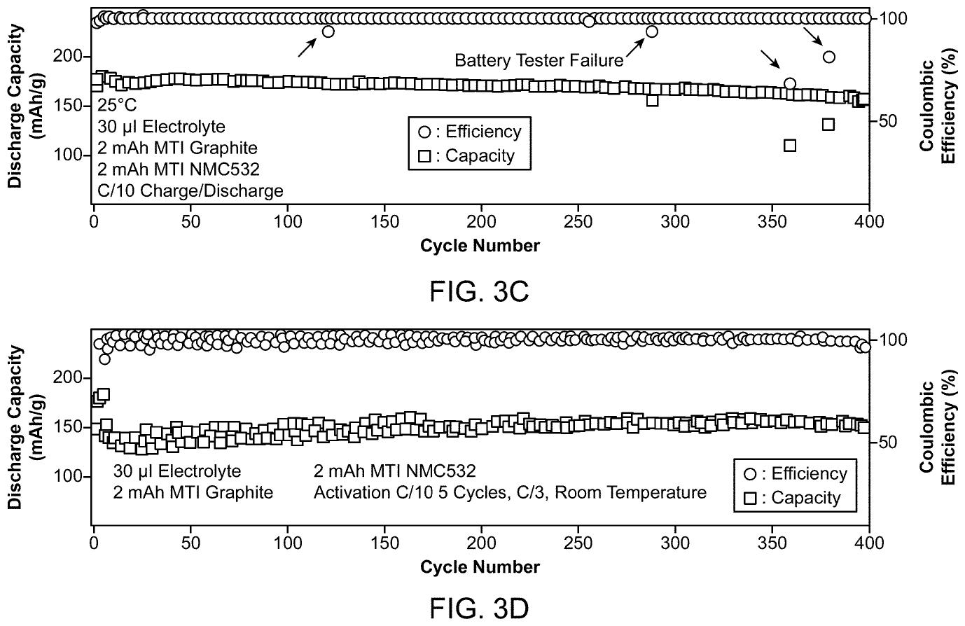

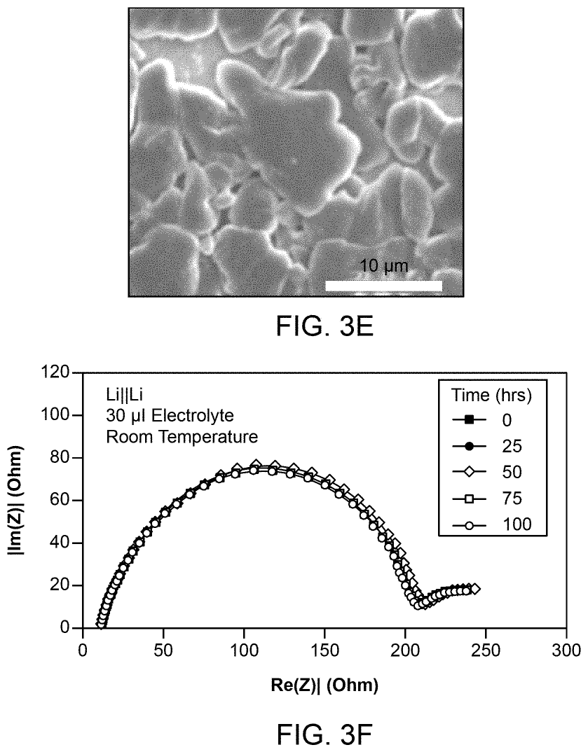

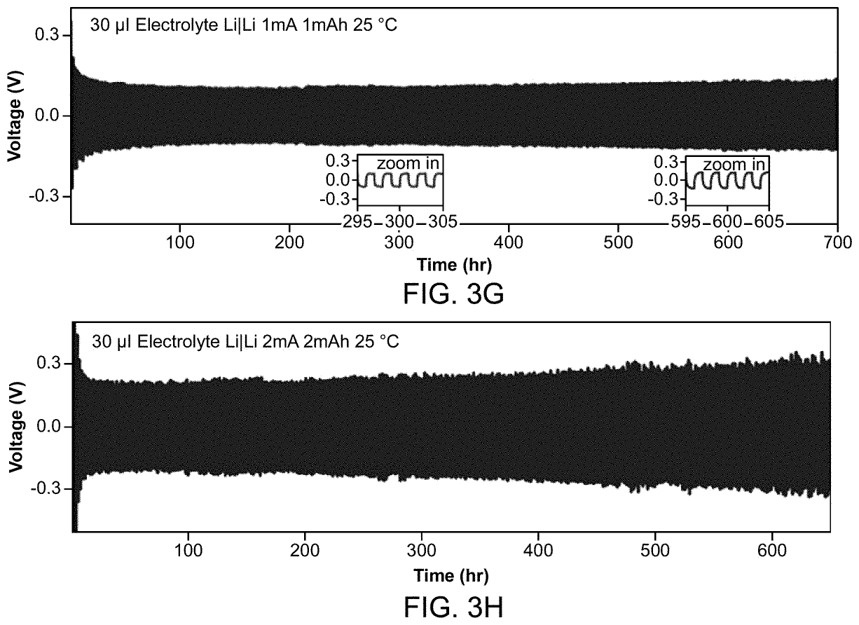

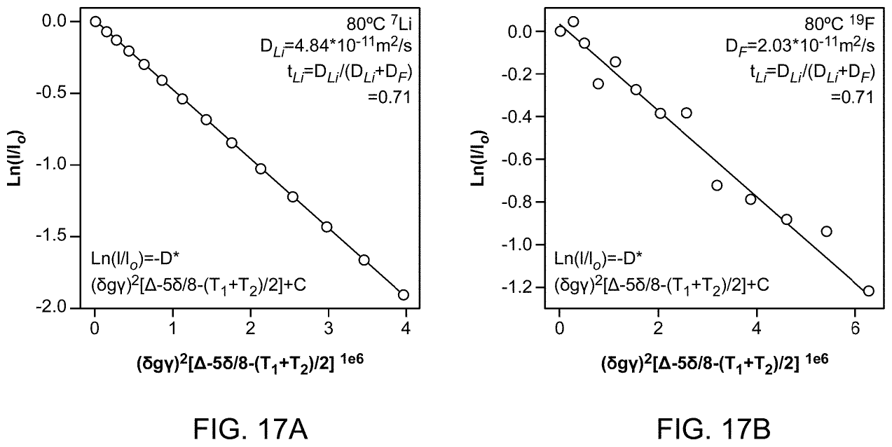

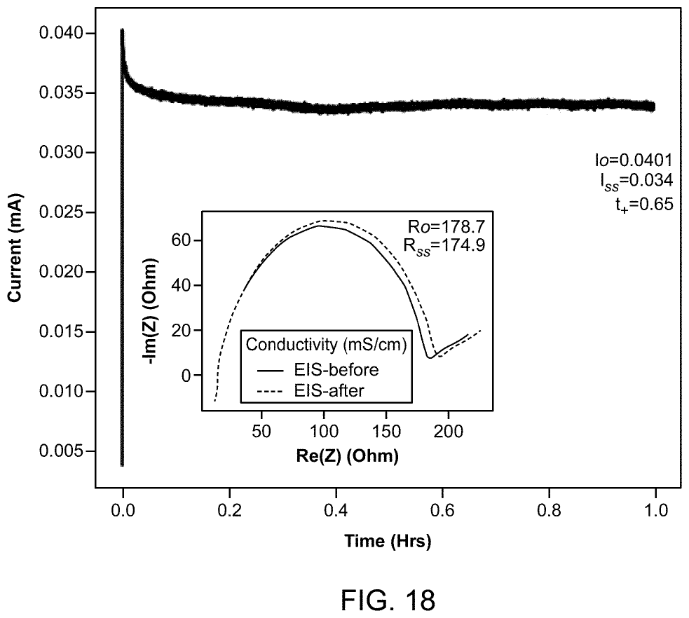

Selected was PPyMS-FSI r=8 for further electrochemical studies since it was observed that further increase in salt concentration has negligible effect on its ionic conductivity. Before applying it for long-term cycling in cells, first examined was the oxidative stability of this electrolyte in Li|Al cell. Performed was linear voltammetry on the cell and identified was the oxidation voltage of PPyMS-FSI r=8 electrolyte as 6.7 V vs. Li (FIG. 3A). Such a high oxidative potential is sufficient for pairing with high-voltage nickel-manganese-cobalt (NMC) electrodes. The high oxidative stability was attributed to the electrolyte's high salt content and stable components (ionic liquids). Next, the transference number of the lithium and fluorine nuclei was measured at 80° C. using diffusion ordered spectroscopy (DOSY) NMR technique. FIGS. 17A and 17B show the details on the linear fitting and the calculated diffusion coefficient. The transference number of this electrolyte was computed to be 0.71, indicating that most of the mobile species in the system were Li⁺. Also measured was the transference number through electrochemical polarization in Li|Li symmetric cell (FIG. 18), and the transference number was calculated as 0.65. This is consistent with the DOSY-NMR measurement value, and in both measurements, it was assumed that the Nernst-Einstein relationship was obeyed, and the system was at the dilute limit. This is a simplified model that does not account for un-dissociated ion pairs/triplets, but it does offer useful insight regarding the ion movements in the electrolyte.

Long Term Stability and Battery Operation

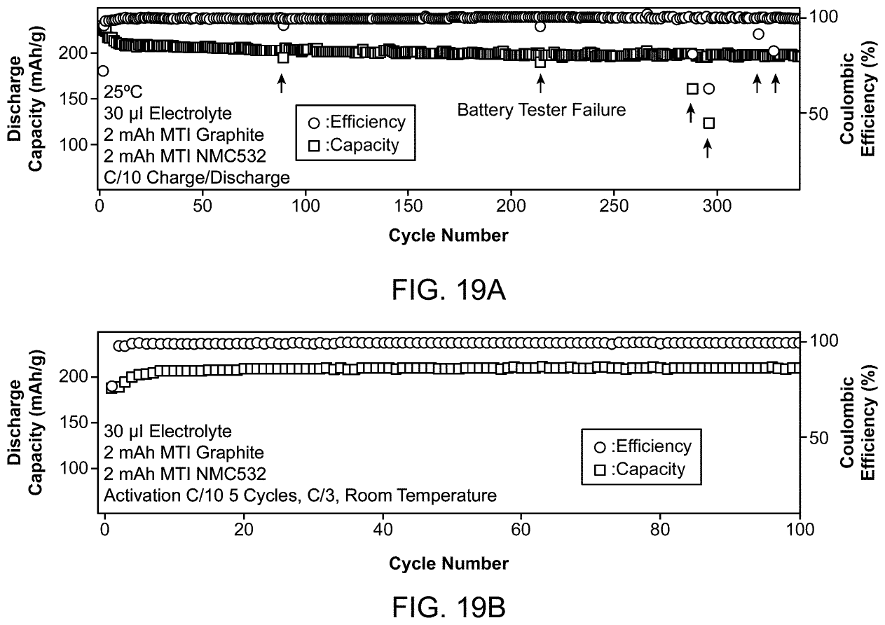

Next examined was the cycling of the electrolyte in graphite|NMC full cell set-up. The C-rate dependent test was conducted (FIG. 3B), and it was found this electrolyte has ˜150 mAh/g capacity at C/3 and ˜170 mAh/g capacity at C/10, when pairing with commercially available NMC cathode (MTI, 2 mAh/cm²). Cycled were these graphite|NMC cells at lean electrolyte (30 μL) condition at C/10 c-rates, and observed was negligible capacity fading for over 400 cycles (FIG. 3C). The long-term cycling performance of two repetitions cells are shown in FIGS. 19A and 19B, and both demonstrated stable long-term performance with no observed capacity fading. For the C/3 cells, also showed was stable long-term performance for over 400 cycles with no apparent capacity fading (FIG. 3D). The fluctuation of the discharge capacities in the initial 200 cycles was attributed to the changes in the room temperature over different periods of the day, and the fluctuation was reduced once the temperature of the room was set at 25° C.

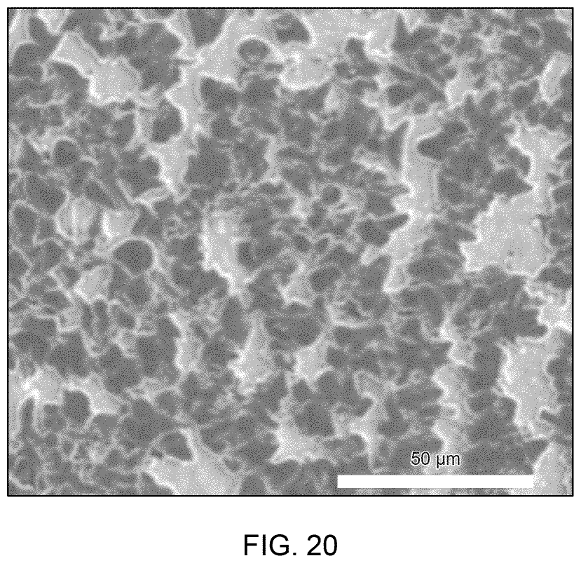

Then evaluated was the electrolyte's compatibility with Li metal anode. Deposited was 1 mAh/cm² of lithium metal on a Cu foil at a current density of 0.1 mA/cm². The scanning electron microscopy (SEM) deposition profiles of the lithium metal (FIG. 3E) indicated that the morphology of the deposited lithium metal was granular and homogenous. A zoomed-out SEM image indicated this morphology was observed over large areas on the electrodes (FIG. 20). The stability of the solid electrolyte interface (SEI) was further characterized by tracking the interfacial impedance of Li|Li symmetric cells over a prolonged period (˜100 hrs) using electrochemical impedance spectroscopy (EIS) measurement. It was observed that the interfacial impedance remained almost unchanged after resting at room temperature for 100 hrs, indicating that a stable interface was formed between lithium metal and the electrolyte (FIG. 3F). Evaluated was the long-term stability of the r=8 electrolyte with lithium metal by cycling Li|Li cells at room-temperature at various current densities. At current densities of 1 mA/cm² and capacity of 1 mAh/cm², PPyMS-FSI r=8 electrolytes showed a prolonged stable cycling of >700 hrs (FIG. 3G). At a higher current density of 2 mA/cm² and capacity of 2 mAh/cm², the electrolyte demonstrated stable cycling for more than 650 hrs (FIG. 3H).

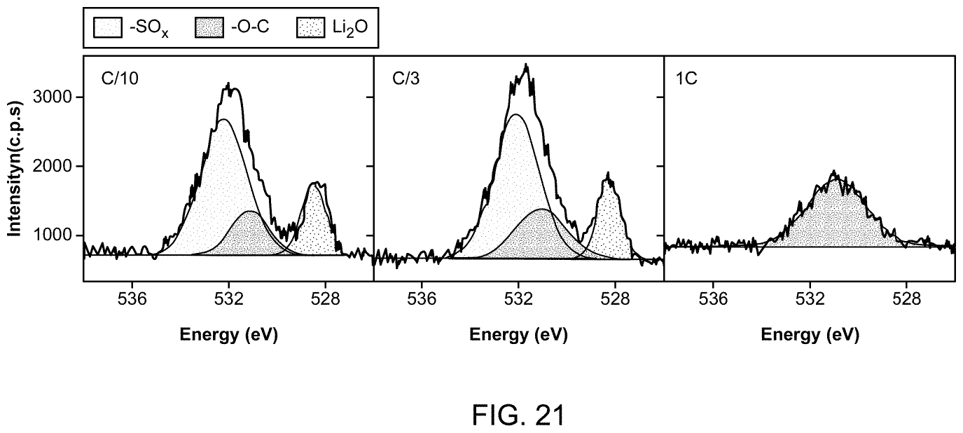

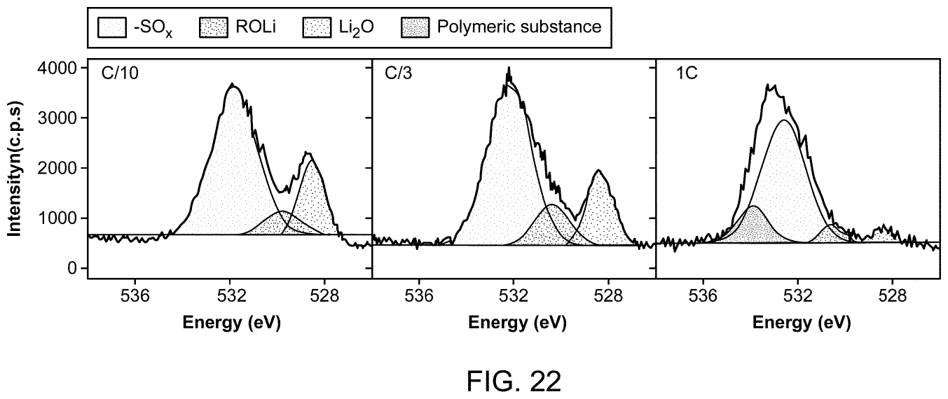

Also characterized was the chemical composition of the solid-electrolyte interphase (SEI) after cycling at different C-rate for both the Li metal and the graphite anode. The graphite anode cycled at either C/10 or C/3 shared similar chemical composition, with product from salt (Li₂O, —SOx) and solvent/polymer (—O—C) decomposition (FIG. 21). At 1C rate, the charge/discharge process turned capacitive, and the anode surface was mostly covered with organic decomposition products (—O—C). Similar trend was discovered on lithium metal anodes, where the anode cycled at 1C rate had significantly different surface chemistry, compared to the electrode cycled at C/3 or C/10 (FIG. 22).

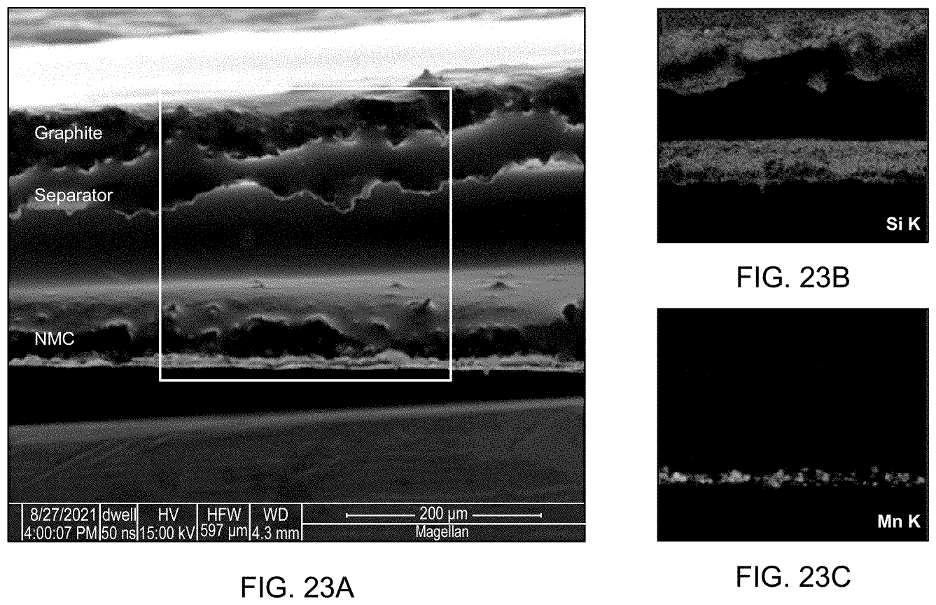

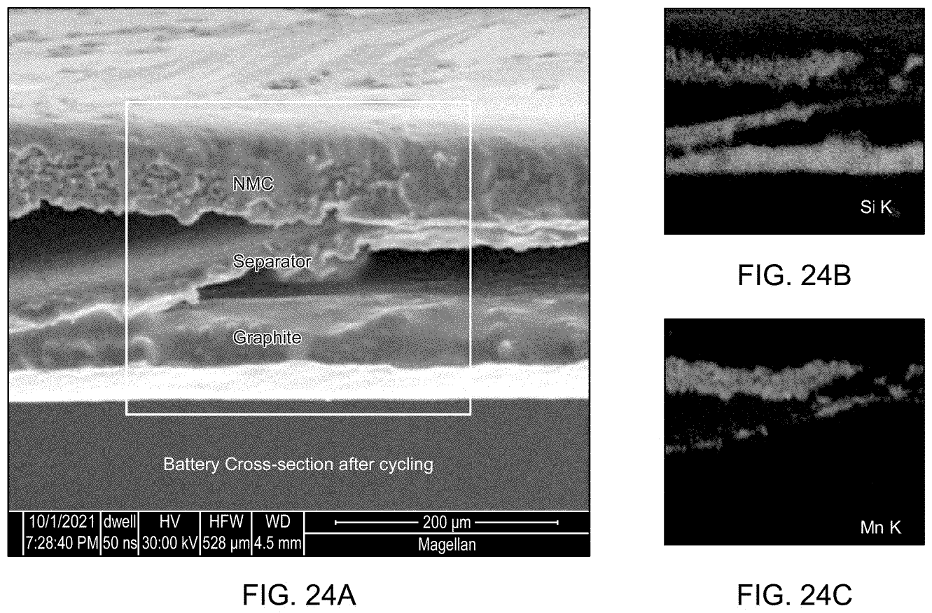

Specifically, more polymeric substance, possibly resulting from either polymer or the solvent decomposition, appeared on the anode surface, and less product derived from salt composition (Li₂O, —SOx). Cross-sections of a graphite|NMC cell were taken before and after 50 cycles of cycling (FIGS. 23A-C and FIGS. 24A-C), and the PPyMS-FSI r=8 electrolyte remain wetted at the electrodes and the separator after the cycling.

Thermal Stability and Electrolyte's Window of Operation

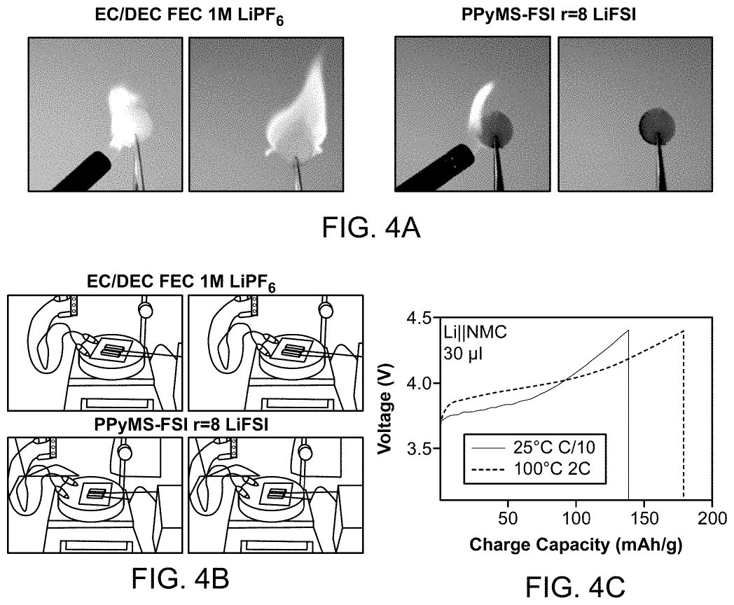

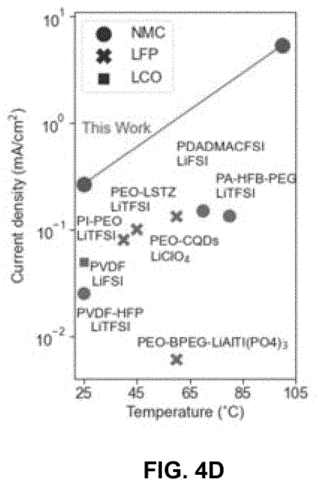

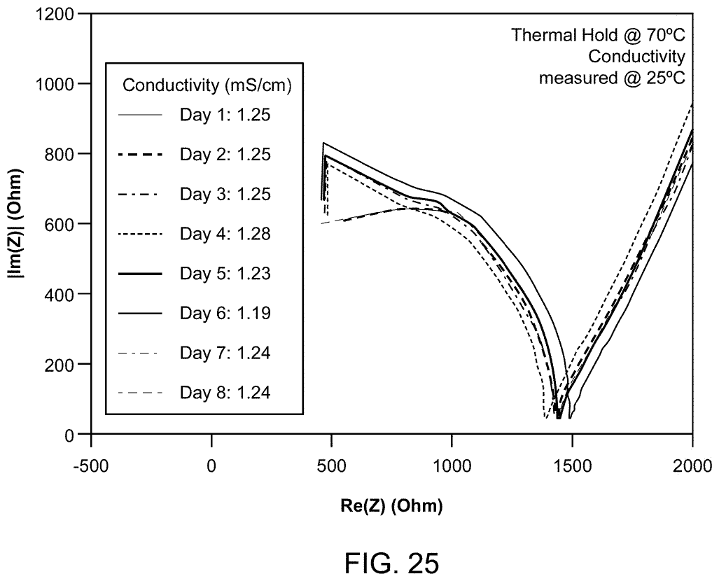

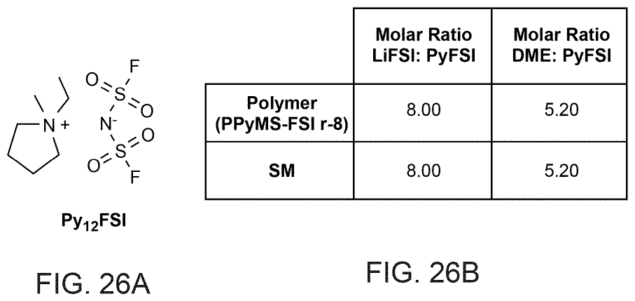

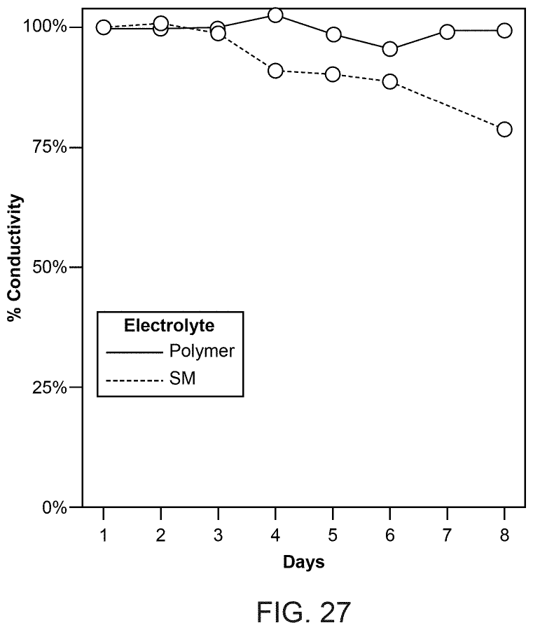

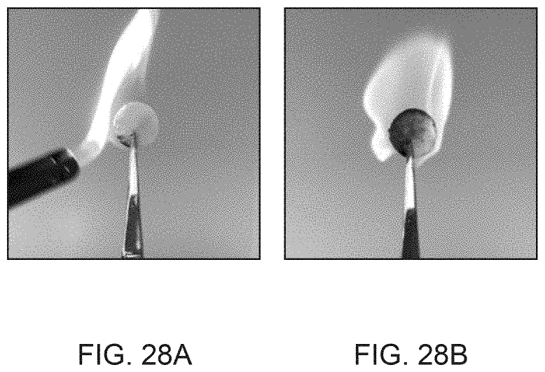

The long-term thermal stability of the cell was investigated, where the cell was placed in a 70° C. oven for prolonged periods of time, and the conductivity remained unchanged after 8 days, as shown in FIG. 25. To demonstrate the effect of polymer on improving the electrolyte's thermal stability and safety feature, also synthesized were small molecule Py12FSI ionic liquids and composed a small molecule-based electrolyte with the same molar ratio of DME, LiFSI and PyFSI, and this electrolyte was named electrolyte SM. Detailed composition of the SM electrolyte was shown in FIGS. 26A and 26B. Also compared was the long-term thermal stability between the polymer and the SM electrolyte, where it was found that SM electrolyte's conductivity starts to drop after 3 days of thermal hold at 70° C., while the PPyMS-FSI r=8 polymer's conductivity remained unchanged after 8 days of thermal (FIG. 27). The thermal stability of these electrolytes was further evaluated with a flammability test. First prepared was a glass wool soaked with 1 ml of either PPyMS-FSI r=8 or EC/DEC 1M LiPF₆ 10% FEC electrolyte. Next, a flame torch was placed near the soaked glass wool for 3 seconds before removing the flame, and snapshots of the process was shown in FIG. 4A. For the carbonate electrolyte, the combustion was sustained until all the liquids were exhausted. For the PPyMS-FSI r=8 electrolyte, only slight charring was observed on the glass wool (possibly due to salt and polymer degradation); more importantly, combustion was not sustained. In comparison, the SM electrolyte is flammable, and the combustion was sustained until all the electrolytes were burnt to black substance (FIGS. 28A and 28B).

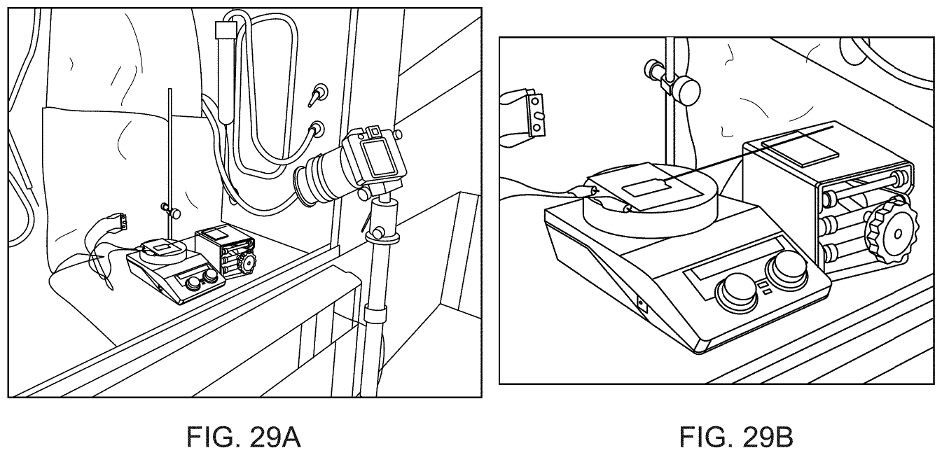

Beyond flammability, one is also interested in probing the outgassing and temperature operation window of this electrolyte. Hence, it was proceeded to first assemble battery pouch cells with either the PPyMS-FSI r=8 or EC/DEC 1M LiPF₆ 10% FEC electrolyte. After, the pouch cell was used to operate an LED, while being heated on a hotplate to preset desired temperatures. The collected experimental results and pictures of the camera setup are shown in FIGS. 29A and 29B and a snapshot of this setup is in FIG. 4B. For the carbonate-based electrolyte, the LED was abruptly turned off when the hot plate was heated up to 95° C., most likely due to the loss of ionic conduction pathway in the pouch cell from electrolyte evaporation and degradation. In contrast, the LED with the polymer-based electrolyte remained lit even after holding the hotplate temperature at 100° C. for 6 minutes.

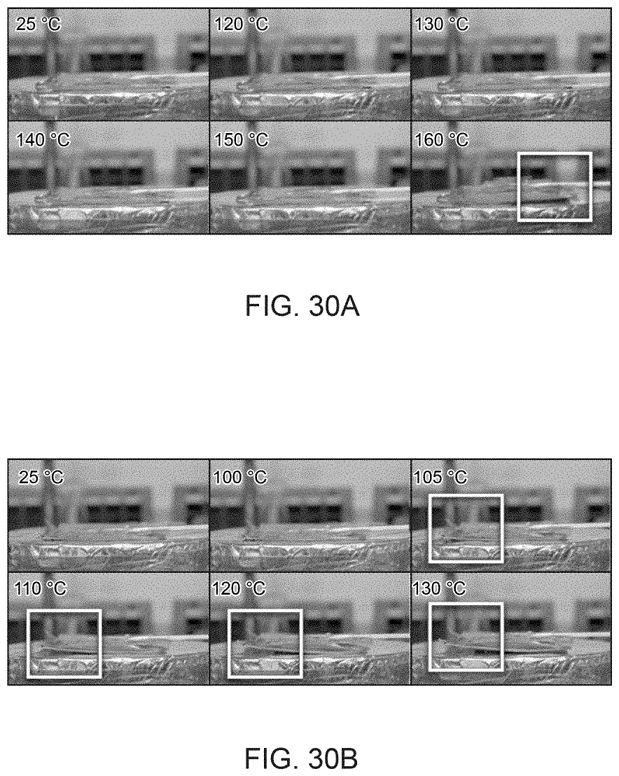

Further demonstrated was the thermal stability of the PPyMS-FSI r=8 electrolyte by recording the temperature where significant outgassing occurred. Tapped was the graphite|NMC pouch cell to the hot plate with Kapton tapes and compared the outgassing behavior of the polymer electrolyte with EC/DEC+10% FEC electrolyte (FIGS. 30A and 30B). The pouch cell with the polymer electrolyte did not show outgassing until the temperature reaches 160° C. At that temperature, the corners of the cell rise from the pouch inflation. For the EC/DEC electrolyte, due to the volatility of the DEC molecules, it was observed the pouch cell was inflated from solvent vapor pressure starting at 105° C. It is noted that significant outgassing of the polymer electrolyte happened at a temperature (160° C.) higher than that of salt decomposition (140° C.), indicating that salt decomposition instead of solvent outgassing is the reason of electrolyte thermal failure.

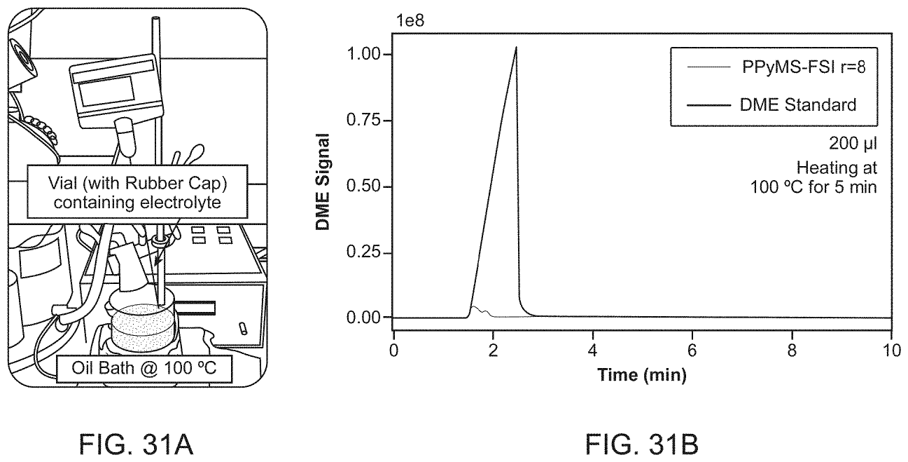

To quantify the volatility of the DME solvents in the polymer electrolyte system and to compare that with other electrolyte systems, measured was the relative saturation of different organic solvents in different electrolytes at 100° C. with gas chromatography (GC) chamber (FIGS. 31A and 31B). By integrating the area under the curve for the solvent signal peak in the GC output and calculating the integration ratios between electrolytes and standard solvent samples, obtained esd the relative saturation values, listed in Table 2 below. For the PPyMS-FSI r=8 electrolyte, after drying in the vac oven for 48 hrs, the relative saturation of DME is 2%. Further extending the drying to 96 hrs lowered the relative saturation to 0.6%. Especially, it was noted the difference between this polymer liquid electrolyte and other classic gel electrolytes by measuring the relative saturation of the lowest boiling point component in two widely reported PVDF-HFP based gel electrolytes. In both cases, the relative saturations were orders higher (38%, 80%) than our reported polymer electrolyte. Similarly, also measured was the relative saturation for classic carbonate electrolyte (EC/DEC) and high concentration ether electrolyte (4M LiFSI DME), and it was found their relative saturations were also orders higher (94%, 84%, respectively). It was also found the relative saturation of DME for SM electrolyte was more than two-fold that of PPyMS-FSI r=8 electrolyte. This series of measurements showcased that the residual DME in the polymer electrolyte has significantly lower volatility than the organic solvents in other gel, and other high concentration (ionic liquid based) electrolytes.

TABLE 2

| | Organic liquid | | Gel | | Ionic liquid | Polymer liquid | |
|---|---|---|---|---|---|---|---|
| Type | electrolyte | | Electrolyte | | Electrolyte | electrolyte | |
| Composition | EC/DEC | 4M LiFSI | EC/EMC | PC/DEC | Py12FSI | PDMS | PDMS |
| | 1M LiPF6 | DME | 1M LiPF6 | (60 wt %) | LiFSI | PyFSI | PyFSI |
| | 10% FEC | | PVDF- | LiClO4 | DME | r = 8 | r = 8 |
| | | | HFP (50 | (15 wt %) | (SM) | (48 hrs) | (96 hrs) |
| | | | wt % | PVDF- | | | |
| | | | Kynar | HFP | | | |
| | | | Flex ® | (25 wt % | | | |
| | | | 2800-00) | Kynar | | | |
| | | | | Flex ® | | | |
| | | | | 2800-00) | | | |
| Solvent | DEC | DME | EMC | DEC | DME | DME | DME |
| Relative | 94% | 84% | 38% | 80% | 5% | 2% | 0.6% |
| Saturation @ | | | | | | | |
| 100° C. | | | | | | | |

To determine the operational range and the rate capability of the polymer-based electrolyte at different temperature, we cycled Li|NMC cells at both 25° C. and 100° C. to chart the rate capability of the electrolyte (FIG. 4C). To reach our targeted capacity of 130 mAh/g, at 25° C., it was observed that a c-rate of C/10 was needed, and at 100° C., a c-rate of 2C was sufficient. This liquid-state polymeric electrolyte achieved a current density of 0.27 mA/cm² at 25° C. and 5.4 mA/cm² at 100° C. when paired with commercially available NMC cathodes. It was noted that the obtained current densities are compared to that of other dry polymeric electrolytes (FIG. 4D).

Possible Salts, Solvents, Solvating Units/Coordinating Molecules

In the examples provided herein, an LiFSI salt incorporated into the electrolyte has been described in detail. However, this should not be construed as limiting. Rather, electrolytes according to embodiments can include lithium and sodium salts comprising Li+ or Na+ as cations and Type 1 or Type 2 anions having the form illustrated below:

Cations: Li⁺ or Na⁺

### Anions:

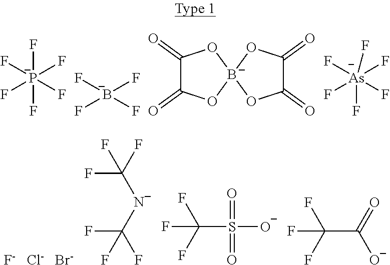

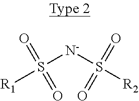

R1, R2=F, (Fluorinated) Alkyl chain (C1-C10), (Fluorinated) Aromiatics can be the same or different from each other

### Key Examples

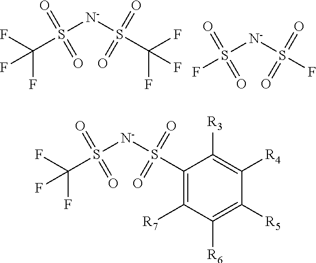

R3, R4, R5, R6, R7=F, (Fluorinated) Alkyl chain (C1-C10) can be the same or different from each other

### Any Combination of Cations and Anions

Moreover, various side chain modifications to the polymer to solvate salt and salt coordinating solvents that can be added to the electrolyte are possible (e.g. where the ion coordinating molecule is other than a dimethoxyethane (DME) solvent and/or wherein the flexible polymer is something other than polysiloxane tethered with ion solvating moieties). Various examples of these and other alternatives that can be used in electrolytes according to embodiments are provided in the Appendix, which forms part of the present disclosure and is incorporated herein by reference in its entirety.

### CONCLUSION

In summary, the present embodiments relate to a concept of incorporating coordinate solvent molecules into polymer electrolyte to give a non-flammable polymeric electrolyte with high room temperature conductivity. By employing an amphiphilic polymer design of the siloxane backbone and ionic-liquid-functioned side chains, we increased the salt solubility of the polymer. By tuning the salt and coordinated solvent content in this electrolyte, we maximized the ionic conductivity (1.6 mS/cm, 25° C.) without undermining the safety feature or the thermal stability of the electrolyte. This electrolyte addresses the manufacturing difficulty of solid-state electrolyte (polymer and ceramic based) by being in liquid-state and can be readily integrated with commercially available electrodes and separators. The electrolyte shows stable long-term operation in graphite|NMC full cell and has an operation range of 25° C. to 100° C. The polymer electrolyte design concept results in a marked improvement in the ionic conductivity and manufacturability of next-generation safe polymer-based electrolytes.

### Example Materials

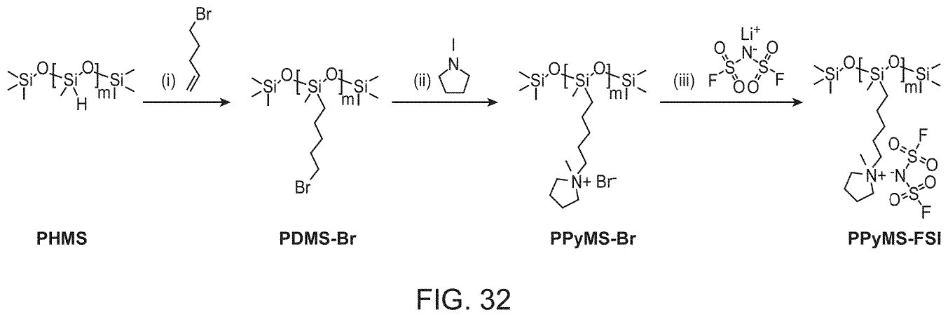

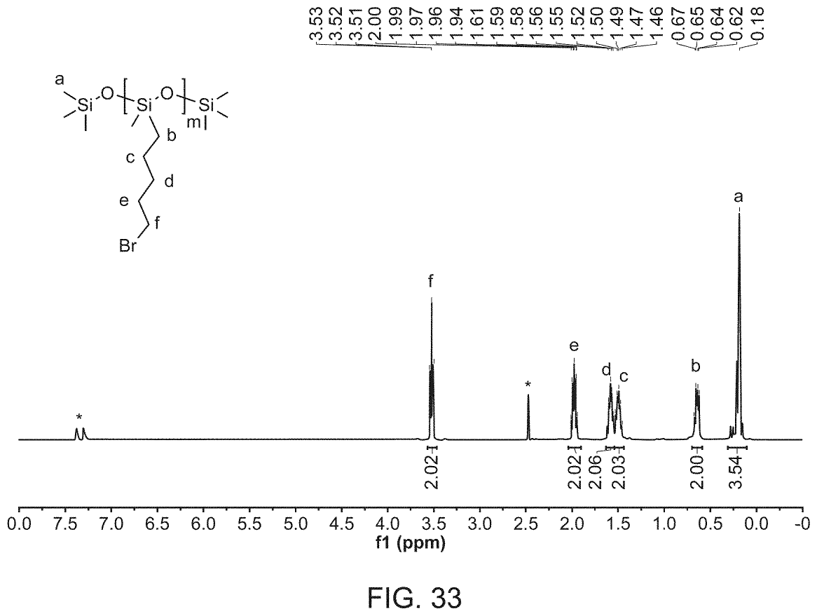

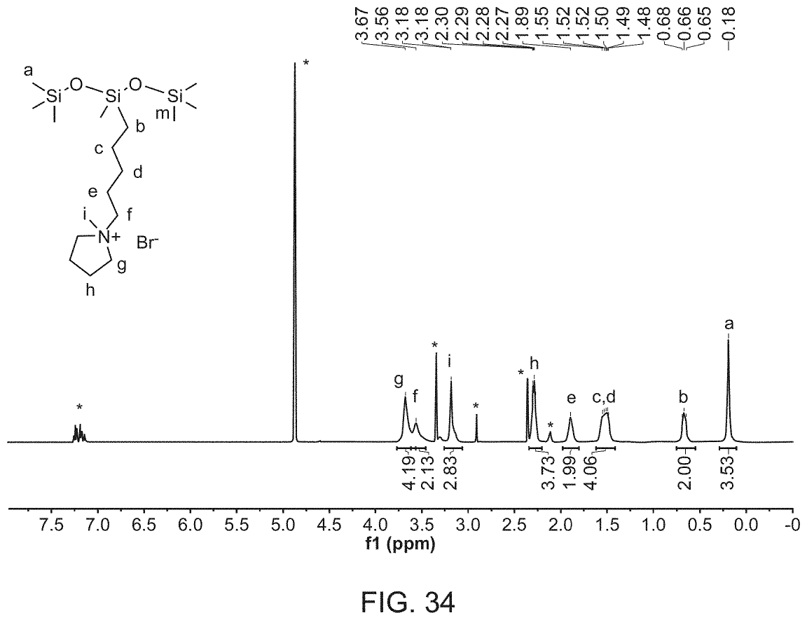

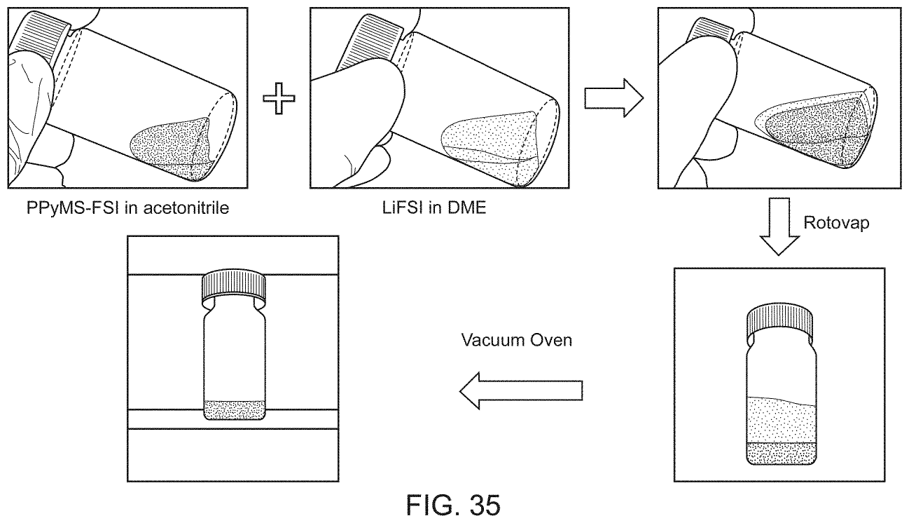

Polymethylhydrosiloxane, trimethylsilyl terminated (PHMS, 100 mol % Hydride, Mw=2100-2400 g/mol) was purchased from Gelest. The Karstedt catalyst solution (Pt, 2% in xylene) was purchased from Santa Cruz Biotechnology. The 5-bromo-1-pentene, N-Methylpyrrolidine, lithium bis(fluorosulfonyl)imide (LiFSI) and other chemicals and solvents were purchased from Sigma-Aldrich. All the chemicals were used as received without further purification. Synthesis details of the PDMS-PyFSI electrolytes are listed in connection with FIGS. 32-35.

Example Materials Characterization and Simulation

Proton NMR spectra were recorded on a Bruker DRX 500 NMR spectrometer in deuterated solvents at 25° C. Lithium NMR spectra were recorded on Varian Inova 500 NMR spectrometer at 25° C. The chemical shift of the lithium ion was compared with a standard solution of 1M LiClO₄ in D20 to evaluate the changes in lithium shift relative to natural field shifting. The sample was preserved in an Ar atmosphere with epoxy sealing the NMR tube. The diffusion constants of the lithium ion were measured with pulse-field gradient NMR (DOSY NMR) on a 600 MHz Bruker Avance III. The samples were prepared with a sealed D-DMSO tube inserted in the middle for shimming and locking purposes. Then the sample was sealed with a Teflon tape in an Ar environment. The DOSY NMR measurements were carried out at the effective diffusion delay Δ=0.5 s and the gradient pulse duration δ=18 ms at 80° C. The signal decay was fitted to Gaussian function to extract out the diffusion constant. Differential scanning calorimetry (DSC) experiments were performed using a TA Instrument Q2000 differential scanning calorimeter. The temperature range was −80° C. to 100° C. under the heating/cooling rate of 5° C. min⁻¹. The glass transition temperature was recorded on the sample during the second heat cycle. FT-IR spectra were recorded with a Nicolet iS50 FTIR Spectrometer under the attenuated total reflectance (ATR) mode. The viscosity and rheological behaviors were evaluated on a TA Instrument ARES-G2 system with a parallel plate geometry. Frequency sweeps (1-100 rad/sec) were performed at 2% strain at 25° C., 35° C. and 45° C. and time-temperature-superimposed to 25° C. Raman spectra were measured at 25° C. on a Horiba XploRA+Confocal microscope with 532 nm laser while the polymeric electrolyte samples are sealed between two glass slides with epoxy. The conductivity of the polymeric electrolyte was measured with a biologic VMP3 system by impedance spectroscopy over a frequency range from 100 mHz to 7 MHz. The samples were sandwiched between two stainless steel spacers in a 2032 coin cell. A Teflon ring spacer with inner hole area of 0.044 cm² and thickness of 0.079 cm was used to confine the volume of the polymer sample. The X-ray Photoelectron Spectroscopy (XPS) of the deposited lithium surface with PHI VersaProbe 3 using a sputtering power of 5 kV and 3 μA, and the sample surface was sputtered with an ion beam for 1 min before the XPS spectrum was taken. Molecular Dynamic (MD) simulation details are summarized in Table 3 below.

TABLE 3

| | Number of | Number | Number | |
|---|---|---|---|---|
| r | polymer chains | of DME | of FSI | Number of Li⁺ |
| 1 | 13 | 98 | 780 | 390 |

Example Cell Fabrication and Electrochemical Characterization

All coin cell batteries were assembled in an Ar glove box kept at <0.1 ppm water and oxygen content, using 2032 coin cell geometry with 30 μL of the polymeric electrolyte and a 12 μm PE separator in between. Most cells used 304 stainless steel battery casings and spacers from MTI except cells with NMC cathode or cells for oxidation stability measurement, which used the MTI Al-Clad cathode case for high voltage stability. Li|Cu cells were assembled for XPS and SEM measurements; Li|Al cells were assembled for oxidation potential measurement; Li|Li cells were assembled for transference number measurement and long term strip and plate cycling measurement with thick Li metal chip from MTI; Li|NMC cells were assembled with NMC 532 (2.7 mAh/cm² from Argonne national lab) cathodes and thin (50 μm) lithium metal anodes; Graphite|NMC cells were assembled with NMC 532 (2.0 mAh/cm² from MTI) and the corresponding graphite anode. All coin cells were fabricated and rested for 24 hrs before cycling at an Arbin battery tester. Graphite|NMC pouch cells were assembled with NMC 532 cathode (2.0 mAh/cm², 25 mAh, from Argonne national lab), its pairing anode, and 200 μL of electrolyte added. In coin cells, the cathodes were wetted with 10 μl of the electrolyte before the separator and the rest of the electrolyte was added. No cathode modification was performed. All pouch cells were charged to 4.0 V before being placed on a hot plate for temperature stability demonstration. The polymeric electrolyte used in all battery testing was PPyMS-FSI r=8. The liquid electrolyte used is lithium hexafluorophosphate in ethylene carbonate and diethyl carbonate (LiPF₆ EC/DEC 50/50) with 10 vol % of Fluoroethylene carbonate (FEC) added.

Synthesis of PDMS-Br

The PDMS-Br was synthesized by the addition reaction between PHMS and 5-bromo-1-pentene. PHMS (2 g, 30 mmol Si—H) and 5-bromo-1-pentene (6.6 g, 45 mmol) were charged in a 250 mL three-necked flask equipped with a reflux condenser and a magnetic stirrer. Toluene (100 mL) was added, and the mixture was stirred under an inert atmosphere to dissolve the reactant. Then, 0.1 mL of Karstedt catalyst solution (Pt, 2% in xylene) was added via a syringe, and the mixture was heated at 85° C. for 12 h. After the reaction, toluene and the remaining 5-bromo-1-pentene was removed under vacuum, and the PDMS-Br was obtained as a viscous light-gray liquid (6.2 g, yield 96.9%). 1H NMR (500 MHz, CDCl3, δ): 3.52 (t, 2H, CH2), 1.96 (m, 2H, CH2), 1.56 (m, 2H, CH2), 1.47 (m, 2H, CH2), 0.65 (m, 2H, CH2), 0.18 (m, 3H, CH3). As shown in FIG. 22, the disappearance of the peak at δ=4.69 (the characteristic peak of Si—H) confirmed the addition reaction was complete and no residual Si—H. There are no peaks from δ=4.0 to δ=6.0 indicate the remaining reagent 5-bromo-1-pentene was totally removed.

Synthesis of PPyMS-Br

The PPyMS-Br was synthesized by the reaction between PDMS-Br and N-Methylpyrrolidine. PDMS-Br (6.2 g, 30 mmol), N-Methylpyrrolidine (3.825 g, 45 mmol) and toluene (100 mL) were charged in a 250 mL three-necked flash equipped with a reflux condenser and a magnetic stirrer. After completely dissolved, the mixture is heated at 85° C. for 24 h. As the reaction progressed, the insoluble product gradually formed. After 24 h, the insoluble product was collected by the filter and washed by 50 mL toluene three times to remove the excess N-Methylpyrrolidine and unreacted reagent. Then, the collected product was dissolved in Methanol (50 mL) and additional N-Methylpyrrolidine (3.825 g, 45 mmol) was added. The mixture was charged in a 250 mL three-necked flash and refluxed at 70° C. for 12 h. After the reaction, the solution was concentrated into about 20 mL and a large amount (150 mL) of toluene was added to precipitate the product. The precipitated product was collected and dissolved in 20 mL methanol and repeat the precipitation process three times. Finally, the product PPyMS-Br was dried under vacuum and obtained as a light-yellow solid (7.39 g, yield 84.5%). 1H NMR (500 MHz, MeOD, δ): 3.67 (br., 4H, CH2), 3.56 (br., 2H, CH2), 3.18 (br., 3H, CH3), 2.28 (t., 4H, CH2), 1.89 (m, 2H, CH2), 1.52 (m, 4H, CH2), 0.66 (t, 2H, CH2), 0.18 (m, 3H, CH3) (FIG. 23).

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. An electrolyte comprising:
a lithium or sodium salt;
a lithium or sodium ion coordinating molecule; and
a flexible polymer with ion solvating moieties.

2. The electrolyte of claim 1, wherein the salt is a LiFSI salt.

3. The electrolyte of claim 1, wherein the ion coordinating molecule is a dimethoxyethane (DME) solvent.

4. The electrolyte of claim 1, wherein the flexible polymer is polysiloxane tethered with ion solvating moieties.

5. The electrolyte according to claim 4, wherein the polysiloxane tethered with ion solvating moieties is a non-polar siloxane backbone and an ionic-liquid based solvating unit as polymer side chains.

6. The electrolyte according to claim 4, wherein the polymer side chains comprise a pyrrolidinium (Py) bis(fluorosulfonyl)imide (FSI) polar ionic side chain.

7. The electrolyte according to claim 3, wherein the DME coordinates with both the salt and the flexible polymer.

8. The electrolyte according to claim 1, comprising FSI anions and Li cations.

9. The electrolyte according to claim 1, comprising small molecules participating in coordination with Li ions together with the flexible polymer.

10. The electrolyte according to claim 1, wherein the electrolyte is a liquid polymer electrolyte.

11. A graphite|NMC cell including the electrolyte of claim 1.

12. A Li|Li cell including the electrolyte of claim 1.

13. A method of preparing an electrolyte comprising:
dissolving LiFSI salt in DME (dimethoxyethane);
dissolving PPyMS-FSI polymer in ACN (acetonitrile);
drying in a vacuum oven; and
removing the ACN.

14. The method of claim 13, wherein removing the ACN results in formation of DME coordinated structures with polymers and salts.

15. The method of claim 14, wherein the salt content defined as a molar ratio between added LiFSI salt and PyFSI polymer side chains is about 8.

16. The method of claim 15, further comprising optimizing the DME amount by controlling the drying time.

17. The method of claim 13, further comprising tuning the salt and coordinated solvent content so as to maximize ionic conductivity.
